(19) United States
(12) Patent Application Publication
(10) Pub. No.: US 2006/0280949 A1
(43) Pub. Date: Dec. 14, 2006

(54) Method for making amine-modified epoxy resin and cationic electrodeposition coating composition

(76) Inventors: Shinsuke Shirakawa, Osaka (JP); Toshiaki Indou, Aichi (JP); Yasuo Mihara, Osaka (JP); Naotaka Kitamura, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 11/450,409

(22) Filed: Jun. 12, 2006

(30) Foreign Application Priority Data
Jun. 13, 2005 (JP) 2005-172380
Jun. 13, 2005 (JP) 2005-172385

(51) Int. Cl. B32B 27/38; C08L 63/00; C08G 65/00; B32B 27/40

(52) U.S. Cl. 428/418; 525/528; 528/119; 204/505

(57) ABSTRACT

The present invention provides a cationic electrodeposition coating composition having good appearance of coated film and high throwing power, and a method for making an amine-modified epoxy resin used for the cationic electrodeposition coating composition. The present invention relates to a method for making an amine-modified epoxy resin comprised in a cationic electrodeposition coating composition comprising the steps of: providing a half blocked isocyanate by reaction of an isocyanate compound with a blocking agent, preparing a blocked prepolymer by reaction of the half blocked isocyanate with a polyol, forming an epoxy resin containing oxazolidone ring by reaction of the blocked prepolymer with a diglycidyl ether type epoxy resin, chain-extending the epoxy resin containing oxazolidone ring with at least saturated or non-saturated hydrocarbon group containing dicarboxylic acid, and modifying the chain-extended epoxy resin with an amine.

### FIELD OF THE INVENTION

The present invention relates to a cationic electrodeposition coating composition having good appearance of coated film and high throwing power, and a method for making an amine-modified epoxy resin used for the cationic electrodeposition coating composition.

### BACKGROUND OF THE INVENTION

It is possible to meticulously coat materials to be coated having complicated structures by electrodeposition coating with a cationic electrodeposition coating composition, and it is possible to automatically and continuously coat it. Therefore, cationic electrodeposition coating has been widely used industrially as a primer for large material to be coated having complicated structures, such as automobile body. Cationic electrodeposition coating is carried out by dipping the material to be coated as cathode with cationic electrodeposition coating composition, and applying a voltage thereon.

Coated film is deposited by electrochemical reaction in the step of conducting electrodeposition coating, and the coated film is deposited on the surface of the material to be coated. Since the deposited coated film has insulation properties, the deposition of the coated film is progressed to increase the deposited film, and electric resistance of the coated film is large. As the result, the deposition of the coating is reduced in the region where the coated film is deposited, and the coated film is deposited in undeposited region. The solid content of the paint is deposited on the material to be coated in order of precedence, and the coating is completed. As used herein, the properties that the coated film is formed in order of precedence in undeposited region of the material to be is throwing power.

If the electrodeposition coating composition is designed such that the electric resistance of the electrodeposition coated film is increased in order to ensure high throwing power in electrodeposition coating, an applied voltage for electrodeposition coating is high, and “gas pin hole” occurs by the generation of hydrogen gas when conducting electrodeposition coating, which degrades the appearance of the coated film. Therefore, it is not preferable. In the cationic electrodeposition coating composition, it is required for the electrodeposition coated film to have high throwing power without degrading the appearance of the coated film by the occurrence of the gas pin hole.

Cationic electrodeposition coating compositions are water-based coatings. However, the electrodeposition coating compositions comprise organic solvent. The organic solvent plays parts of improving the flowability of the electrodeposition coated film and the smoothness of the resulting cured coated film. On the other hand, it has been required to reduce the content of the organic solvent in coating compositions in view of environment consciousness and bad smell around a factory, and the safety of the coating line. Therefore, it has been also required to reduce the content of the organic solvent in the coating compositions without degrading the appearance of the coated film.

In the electrodeposition coating compositions, a lead containing corrosion inhibitor has been comprised in order to impart corrosion resistance thereto. Recently, it is required to reduce the usage of the lead because the lead has a harmful influence on the environment. A lead-free cationic electrodeposition coating without the lead containing corrosion inhibitor is mainly used. However, in the lead-free electrodeposition coating composition, the performance of imparting the corrosion resistance thereto is often degraded. In case of preparing the lead-free cationic electrodeposition coating composition, it is required to further improve various coating performances.

In addition, recently, electrodeposition coating has been often conducted on a zinc galvanized steel sheet, which formed by galvanizing the surface of the steel sheet. Since the zinc galvanized steel sheet has excellent anticorrosive properties as compared with the conventional steel sheet, it is advantageous to accomplish higher anticorrosive properties if used as a material to be coated. On the other hand, when the zinc galvanized steel sheet is used as a material to be coated, the gas pin hole and crater easily occurs in the resulting electrodeposition coated film. Therefore, it is problem to degrade the appearance of the coated film. It is the reason that spark discharge easily occurs in hydrogen gas because sparking voltage of hydrogen gas generated on the material to be coated is lower than the voltage on the steel sheet. Therefore, if the electrodeposition coating composition which can conduct electrodeposition coating by low applied voltage can be obtained, it is suitable for electrodeposition coating on the zinc galvanized steel sheet, which is useful.

Moreover, electrodeposition coated film having larger thickness is sometimes required for an application to a purpose of high-level design. However, when increasing the applied voltage in order to obtain thicker electrodeposition coated film, the gas pin hole easily occurs.

In Japanese Patent Kokai Publication No. 356647/2002, the lead-free cationic electrodeposition coating composition suggested by the present inventors is disclosed. Thereby the electrodeposition coating composition having high throwing power is obtained, but there has been the requirement for the higher throwing power, and it has been required to consider the ingredient of the binder resin.

In Japanese Patent Kokai Publication No. 329755/1994, a method for producing a modified epoxy resin comprising the steps of:

chain extending by reacting a prepolymer, which is formed by blocking terminal isocyanate group of the prepolymer obtained by the reaction of bifunctional active hydrogen compound as a soft segment and diisocyanate compound, with a diglycidyl ether type epoxy resin, and

opening at least a portion of terminal epoxy rings of the chain-extended epoxy resin with a cationic active hydrogen compound to introduce a cationic group thereinto is disclosed. In this method, the prepolymer is prepared using the isocyanate compound and bifunctional active hydrogen compound, and followed by the reaction of the prepolymer with the diglycidyl ether type epoxy resin. On the other hand, in the present invention, a half blocked isocyanate is prepared using polyol and the like, and it is then chain-extended using saturated or unsaturated hydrocarbon group containing dicarboxylic acid. Therefore, the present invention is different from the invention described in Japanese Patent Kokai Publication No. 329755/1994. According to the method of the present invention, both high throwing power and low content of the organic solvent can be accomplished.

In Japanese Patent Kokai Publication No. 306327/1993, a method for producing a water-based coating, particularly hydrophilic resin for electrodeposition coating comprising:

reacting (a) a resin having terminal epoxy groups and containing oxazolidone rings in the molecule with (b) at least a first active hydrogen compound selected from the group consisting of a monoalcohol, a diol, a monocarboxylic acid and a dicarboxylic acid to open a portion of epoxy rings, and then

opening the remaining epoxy rings with (c) a second active hydrogen compound capable of introducing an ionizable group to introduce the ionizable group thereinto is disclosed. As described above, this method is conducted by the reaction of the resin containing oxazolidone rings with at least a compound selected from the group consisting of a monoalcohol, a diol, a monocarboxylic acid and a dicarboxylic acid. On the other hand, in the present invention, a half blocked isocyanate is prepared using polyol and the like, and it is then chain-extended using saturated or unsaturated hydrocarbon group containing dicarboxylic acid. Therefore, the present invention is different from the invention described in Japanese Patent Kokai Publication No. 306327/1993. According to the method of the present invention, both high throwing power and low content of the organic solvent can be accomplished.

In Japanese Patent Kokai Publication No. 136301/1994, a cationic electrodeposition coating composition comprising: (A) 20 to 70% by weight of a cationic non-gelled resin obtained by neutralizing with acid a reaction product of a polyepoxide and a polyoxyalkylene polyamine in an equivalent ratio of epoxy group in the polyepoxide to amine group in the polyoxyalkylene polyamine being within the range of 1:1.15 to 1.60,

(B) 10 to 65% by weight of a cationic resin other than the cationic non-gelled resin (A), and

(C) 10 to 50% by weight of a blocked polyisocyanate having a dissociation temperature of 100 to 140° C.; based on the total solid content,

is disclosed. In addition, an embodiment that the polyepoxide in the (A) is dimeric acid modified polyepoxide is also disclosed therein. However, the dimeric acid used herein is not used for preparing amine modified epoxy resin, but is used for preparing additives for a coating. Therefore, it is different from the present invention.

In Japanese Patent Kokai Publication No. 213938/2001, amino-polyether-modified epoxy obtained by reacting amino polyether with polyglycidyl ether having a molecular weight of 1,000 to 7,000 and an epoxy equivalent of 500 to 3,500, wherein an equivalent ratio of a primary amino group of the amino polyether to an epoxy group of the polyglycidyl ether is adjusted within the range of 0.52 to 1.0 is disclosed. In addition, an embodiment that dimeric acid is used for preparing the amino-polyether-modified epoxy is also disclosed therein. However, the dimeric acid used herein is not used for preparing amine modified epoxy resin, but is used for preparing additives for a coating. Therefore, it is also different from the present invention.

### OBJECTS OF THE INVENTION

A main object of the present invention is to provide a cationic electrodeposition coating composition having good appearance of coated film and high throwing power, particularly a lead-free cationic electrodeposition coating composition having good appearance of coated film, high throwing power and low content of organic solvent, and a method for making an amine-modified epoxy resin used for the cationic electrodeposition coating composition.

This object as well as other objects and advantages of the present invention will become apparent to those skilled in the art from the following description with reference to the accompanying drawing.

### BRIEF EXPLANATION OF DRAWINGS

The present invention will become more fully understood from the detailed description given hereinbelow and the accompanying drawing which is given by way of illustration only, and thus are not limitative of the present invention, and wherein:

FIG. 1 is a perspective view illustrating one embodiment of the box for evaluating a throwing power in the present invention,

FIG. 2 is a sectional view schematically illustrating a method for evaluating a throwing power in the present invention.

### SUMMARY OF THE INVENTION

The present invention provides a method for making an amine-modified epoxy resin comprised in a cationic electrodeposition coating composition comprising the steps of:

providing a half blocked isocyanate by reaction of an isocyanate compound with a blocking agent,

preparing a blocked prepolymer by reaction of the half blocked isocyanate with a polyol,

forming an epoxy resin containing oxazolidone ring by reaction of the blocked prepolymer with a diglycidyl ether type epoxy resin,

chain-extending the epoxy resin containing oxazolidone ring with at least saturated or non-saturated hydrocarbon group containing dicarboxylic acid, and

modifying the chain-extended epoxy resin with an amine. Thereby the object described above is accomplished.

It is preferable for the diglycidyl ether type epoxy resin used in the step of forming epoxy resin containing oxazolidone ring to have an epoxy equivalent of 150 to 1,000.

It is preferable for the epoxy resin containing oxazolidone ring to have an epoxy equivalent of 800 to 3,000.

It is preferable for the amine-modified epoxy resin to have a dynamic glass transition temperature Tg of 18 to 35° C.

It is preferable for the amine-modified epoxy resin to have a content of diglycidyl ether moiety containing oxazolidone ring of 30 to 70% by weight.

It is preferable for the amine-modified epoxy resin to have a content of dicarbonyl moiety containing saturated or non-saturated hydrocarbon group of 3 to 17% by weight.

The present invention also provides a lead-free cationic electrodeposition coating composition comprising the amine-modified epoxy resin formed by the method.

It is preferable for the lead-free cationic electrodeposition coating composition to comprise an organic solvent in an amount of not more than 0.5%.

The present invention also provides the lead-free cationic electrodeposition coating composition, from which the electrodeposition coated film having a thickness of 15 μm has a membrane resistance of 1,000 to 1,500 kΩ cm².

The term “lead-free” as used herein means that the electrodeposition coating composition does not substantially contain lead and does not contain lead in the amount such that it has a harmful influence on the environment. Concretely, it means that the electrodeposition coating composition does not contain lead in the amount such that the concentration of lead compound in the electrodeposition bath is higher than 50 ppm, preferably 20 ppm.

The present invention provides a cationic electrodeposition coating composition comprising a binder resin emulsion comprising

a binder resin formed from (a) an amine-modified bisphenol type epoxy resin having an amino group; and (b) a blocked isocyanate curing agent; and

an emulsion resin formed from (c) a modified epoxy resin having a quaternary ammonium group, wherein the emulsion resin has an epoxy equivalent of 1,000 to 1,800, and has 35 to 70 meq of the quaternary ammonium group. Thereby the object described above is accomplished.

It is preferable for the binder resin emulsion to have a solid content ratio of (a) the amine-modified bisphenol type epoxy resin having an amino group and emulsion resin formed from (c) a modified epoxy resin having a quaternary ammonium group is 98:2 to 70:30.

Thereby the object described above is accomplished.

It is preferable for the cationic electrodeposition coating composition to have an electrical conductivity of 1,200 to 1,600 μS/cm.

It is preferable for the electrodeposition coated film having a thickness of 15 μm formed from the cationic electrodeposition coating composition to have a membrane resistance of 900 to 1,600 kΩ·cm².

The present invention also provides a process for forming an electrodeposition coated film having restrained occurrence of gas pin pole comprising the step of dipping a material to be coated with the cationic electrodeposition coating composition to conduct electrodeposition coating.

The present invention also provides a process for forming an electrodeposition coating having a dry thickness of greater than 10 μm comprising the step of dipping zinc galvanized steel plate with the cationic electrodeposition coating composition to conduct electrodeposition coating.

The present invention also provides a method of restraining the occurrence of gas pin hole when conducting electrodeposition coating having high throwing power, wherein the cationic electrodeposition coating composition used in the step of conducting electrodeposition coating comprises a binder resin emulsion emulsified by an emulsion resin (c) having an epoxy equivalent of 1,000 to 1,800, and has 35 to 70 meq of the quaternary ammonium group, based on 100 g of the emulsion resin.

The term “an amine-modified bisphenol type epoxy resin” as used herein refers to the resin formed by reacting a bisphenol type epoxy resin with amine to open the epoxy group and introduce amino group.

The term “an amine-modified novolac type epoxy resin” as used herein refers to the resin formed by reacting a novolac type epoxy resin with amine to open the epoxy group and introduce amino group.

The cationic electrodeposition coating composition of the present invention has the advantage of having low-environmental load, because it is lead-free and has low content of organic solvent. It has also high throwing power and low unevenness of drying, and has the advantage of excellent appearance. If the cationic electrodeposition coating composition of the present invention is used as a material to be coated when conducting electrodeposition coating, the appearance of the coated film is excellent when electrodeposition coating on the zinc galvanized steel sheet, on which the gas pin hole easily occurs. The cationic electrodeposition coating composition of the present invention has excellent performance of restraining the occurrence of gas pin hole and it is difficult of the occurrence of spark discharge by hydrogen gas generated when conducting electrodeposition coating, and it has the advantage of accomplishing thicker electrodeposition coated film.

### DETAILED DESCRIPTION OF THE PREFERRED EMBODIMENTS

Cationic Electrodeposition Coating Composition

The cationic electrodeposition coating composition used in the present invention comprises aqueous medium, binder resin emulsion dispersed or dissolved in the aqueous medium, acid for neutralization, organic solvent. The cationic electrodeposition coating composition of the present invention may further contain pigment. A binder resin contained in the binder resin emulsion is a resin component comprising an amine-modified epoxy resin and blocked isocyanate curing agent.

Amine-Modified Epoxy Resin (I)

The amine-modified epoxy resin used in the present invention is epoxy resin modified with amine. The amine-modified epoxy resin is typically prepared using diglycidyl ether type epoxy resin.

The concrete examples of the diglycidyl ether type epoxy resins include bisphenol A type epoxy resins and bisphenol F type epoxy resins. Examples of the bisphenol A type epoxy resins, which are commercially available from Yuka Shell Epoxy Co., Ltd., include Epikote 828 (epoxy equivalent: 180 to 190), Epikote 1001 (epoxy equivalent: 450 to 500), Epikote 1010 (epoxy equivalent: 3000 to 4000) and the like. Examples of the bisphenol F type epoxy resins, which are commercially available from Yuka Shell Epoxy Co., Ltd., include Epikote 807 (epoxy equivalent: 170) and the like. In the present invention, it is preferable to use the diglycidyl ether type epoxy resins having an epoxy equivalent of 150 to 1,000.

The amine-modified epoxy resin comprised in a cationic electrodeposition coating composition of the present invention is an amine-modified epoxy resin formed by modifying epoxy resin having diglycidyl ether moiety containing oxazolidone ring and dicarbonyl moiety containing saturated or non-saturated hydrocarbon group with amine. The amine-modified epoxy resin may be prepared, for example, by a method comprising the steps of:

providing a half blocked isocyanate by reaction of an isocyanate compound with a blocking agent,

preparing a blocked prepolymer by reaction of the half blocked isocyanate with a monoalcohol or polyol,

forming an epoxy resin containing oxazolidone ring by reaction of the blocked prepolymer with a diglycidyl ether type epoxy resin,

chain-extending the epoxy resin containing oxazolidone ring with at least saturated or non-saturated hydrocarbon group containing dicarboxylic acid, and

modifying the chain-extended epoxy resin with an amine.

The steps in the method for making the amine-modified epoxy resin will be schematically explained with the following reaction scheme. In the reaction scheme, the step (1) is the step of providing a half blocked isocyanate, the step (2) is the step of preparing a blocked prepolymer, the step (3) is the step of forming an epoxy resin containing oxazolidone ring, and the step (4) is the step of chain-extending the resulting epoxy resin.

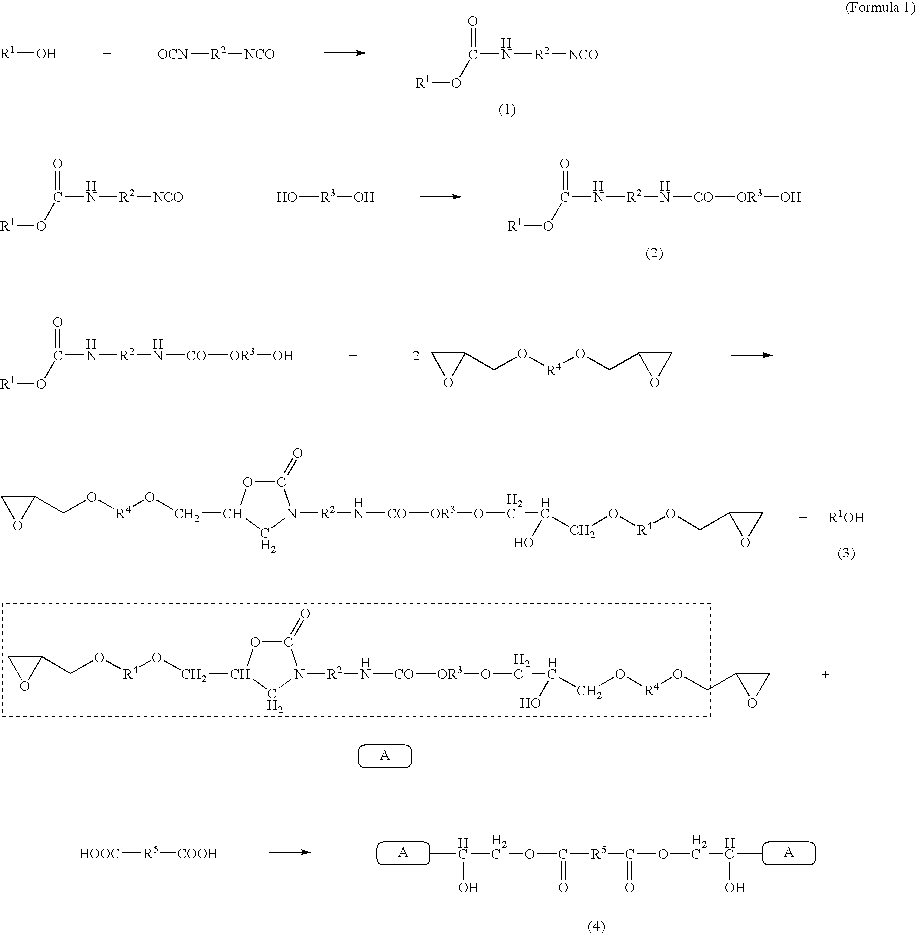

In the reaction scheme (1) to (4), R¹—OH is alcohol as a blocking agent, R² is a residue by removing isocyanate group from isocyanate compound, R³ is a residue by removing hydroxyl group from polyol, R4 is a residue by removing glycidyloxy group from glycidyl ether type epoxy resin, R⁵ is a residue by removing carboxylic acid group from saturated or unsaturated hydrocarbon group containing dicarboxylic acid. Amine-modified epoxy resin is obtained by amine-modifying the acid introduced epoxy resin formed by the reaction formula (4). Each reaction will be explained in order of precedence as described later.

Examples of the isocyanate compounds used in the step of providing a half blocked isocyanate include aromatic diisocyanates, such as 4,4′-diphenylmethane diisocyanate (MDI) and xylylene diisocyanate (XDI); aliphatic and cycloaliphatic diisocyanates, such as hexamethylene diisocyanate (HMDI), isophorone diisocyanate (IPDI), 4,4′-methylene bis(cyclohexyl isocyanate) and trimethyl hexamethylene diisocyanate; and the like.

As the blocking agent used for blocking the isocyanate compound, a blocking agent, which has been used conventionally in the art, may be used. Examples of the blocking agents include aliphatic alcohols, such as methanol, ethanol, isopropanol, n-butanol, 2-ethylhexanol, ethylene glycol monobutyl ether, cyclohexanol; phenols, such as phenol, nitro phenol, ethyl phenol; oximes, such as methyl ethyl keto oxime; lactams, such as ε-caprolactam; and the like. A half blocked isocyanate, which one of the isocyanate groups in the diisocyanate compound is blocked, is obtained by reacting diisocyanate compound with the blocking agent. The diisocyanate compound and blocking agent used in the step are preferably used in the amount such that molar ratio of (NCO group): (active hydrogen) contained respectively is within the range of 1:0.3 to 1:0.7.

The resulting half blocked isocyanate is reacted with hydroxyl group containing compound to obtain a blocked prepolymer (in the step of preparing a blocked prepolymer). Monoalcohol may be used in addition to the polyol. Examples of preferable polyols include aliphatic diols, such as ethylene glycol or propylene glycol; or bisphenols. Examples of preferable monoalcohols include aliphatic monoalcohols and alkyl phenols or glycol monoethers, such as 2-ethylhexanol, nonyl phenol, mono 2-ethylhexylether of ethylene glycol or propylene glycol. It is possible to adjust Molecular weight and/or amine equivalent by reacting them, which improves thermal flow properties and the like.

The half blocked isocyanate and polyol used in the step of preparing a blocked prepolymer are preferably used in the amount such that molar ratio of (NCO group): (hydroxyl group) contained respectively is within the range of 1:0.3 to 1:0.7. The isocyanate group of the isocyanate compound and the hydroxyl group of the polyol are reacted in the step to obtain the blocked prepolymer connected with amide linkage.

The epoxy resin containing oxazolidone ring is obtained by reacting the resulting blocked prepolymer with the diglycidyl ether type epoxy resin (in the step of forming an epoxy resin containing oxazolidone ring). The oxazolidone ring is formed by the reaction of the blocked isocyanate group of the blocked prepolymer with the epoxy group of the diglycidyl ether type epoxy resin in the step. The blocked prepolymer and the diglycidyl ether type epoxy resin are preferably used in the amount such that molar ratio of the blocked isocyanate group: epoxy group contained respectively is within the range of 1:2 to 1:10. The reaction temperature is preferably 60 to 200° C. During the reaction, it is preferable to remove the disengaged blocking agent (such as methanol, ethanol) out of the system by using a decanter.

The resulting epoxy resin containing oxazolidone ring is chain-extended by the reaction thereof with saturated or unsaturated hydrocarbon group containing dicarboxylic acid (in the step of chain-extending the epoxy resin). Examples of the saturated or unsaturated hydrocarbon group containing dicarboxylic acids independently used include, for example, saturated or unsaturated hydrocarbon group containing dicarboxylic acid having 20 to 50 carbon atoms. Examples of the saturated hydrocarbon groups include alkyl group having 5 to 20 carbon atoms. Examples of the unsaturated hydrocarbon groups include alkynyl group, alkadiynyl group, alkatriynyl group, alkenyl group, alkadienyl group, alkatrienyl group and the like.

The saturated or unsaturated hydrocarbon group containing dicarboxylic acid may be polymerized fatty acid, such as dimeric acid. The dimeric acid is generally polymerized fatty acid prepared by the polymerization reaction of unsaturated fatty acid formed from drying oil or semi-drying oil and the like, and is formed from a dimer of fatty acid as a main component. The dimeric acid, as a main example thereof, may be one containing C₃₆ dibasic acid formed by the polymerization of C₁₈ unsaturated fatty acid as a main component. However, since the dimeric acid is polymerized fatty acid, the structure is not single, but is a mixture of non-ring, single-ring and multi-ring structures. In addition, commercially available dimeric acid may contain a small amount of monomeric acid, trimeric acid and the like. Examples of the fatty acids used for the raw material of the dimeric acid include vegetable oil-based fatty acids, such as tall oil, soy oil, coconut oil, caster oil, palm oil or rice bran oil based fatty oils; animal oil-based fatty acids, such as beef tallow-based fatty oil, lard-based fatty oil; and the like.

In the step of chain-extending the epoxy resin, the epoxy resin containing oxazolidone ring and the saturated or unsaturated hydrocarbon group containing dicarboxylic acid are preferably used in the amount such that molar ratio of the epoxy group: the carboxylic acid group contained respectively is within the range of 1:0.03 to 1:0.3. The epoxy group of the epoxy resin containing oxazolidone ring and the carboxylic acid group of the saturated or unsaturated hydrocarbon group containing dicarboxylic acid are reacted in the step to obtain the chain-extended epoxy resin.

In the step of chain-extending the epoxy resin, diol may be used in addition to the saturated or unsaturated hydrocarbon group containing dicarboxylic acid. Examples of the diols used in the step of chain-extending the epoxy resin include aliphatic diols, such as ethylene glycol, 1,2-propylene glycol, 1,3-propanediol, 1,4-butanediol or 1,6-hexanediol; cycloaliphatic diols, such as 1,2-cyclohexanediol or 1,4-cyclohexanediol; aromatic diols, such as bisphenol A, bisphenol F, resorcinol or hydroquinone; bifunctional polyether polyols, such as polyoxyethylene glycol, polyoxypropylene glycol or polyoxytetramethylene glycol, and random or block copolymer thereof; bifunctional polyester polyols formed by the esterification reaction of the diol or polyol and polycarboxylic acid or anhydride thereof, or bifunctional polyester polyols, such as bifunctional polycaprolactone polyol formed by the polymerization reaction of the polyol and caprolactone; and the like. It is preferable for the bifunctional polyether polyol and bifunctional polyester polyol to have a molecular weight of 300 to 3,000.

In the step of chain-extending the epoxy resin, aliphatic monoalcohols, such as n-butanol, butyl cellosolve, octanol or stearyl alcohol; aliphatic monocarboxylic acids, such as acetic acid, lactic acid, butyric acid, octanoic acid, cyclohexane carboxylic acid, lauric acid, stearic acid or 1,2-hydroxystearic acid; or aromatic monocarboxylic acids, such as benzoic acid or 1-naphthoic acid; and the like; may be used in addition to the above components. It is possible to partially open the epoxy ring of the epoxy resin without chain-extending a portion of the epoxy resin by using these compounds.

An amine-modified epoxy resin can be obtained by the reaction of the epoxy resin obtained in the step of chain-extension with amines (in the step of modifying the epoxy resin with amine). In the step of modifying the epoxy resin with amine, the epoxy group in the epoxy resin and amines are reacted. The amines used in the present invention include primary amine, secondary amine. An amine-modified bisphenol type epoxy resin having tertiary amino group can be obtained by the reaction of bisphenol type epoxy resin and secondary amine. An amine-modified bisphenol type epoxy resin having secondary amino group can be obtained by the reaction of bisphenol type epoxy resin and primary amine. An amine-modified bisphenol type epoxy resin having primary amino group can be prepared by using the amine-modified bisphenol type epoxy resin having primary amino group and secondary amino group. The amine-modified bisphenol type epoxy resin having primary amino group and secondary amino group can be prepared by blocking the primary amino group with ketone to form ketimine before the reaction with epoxy resin, and then introducing the ketimine into the epoxy resin to deblocking it.

Concrete examples of the primary amines, secondary amines and ketimines include butylamine, octylamine, diethylamine, dibutylamine, methylbutylamine, monoethanolamine, diethanolamine, N-methylethanolamine; and secondary amines having blocked primary amines, such as ketimine of aminoethylethanolamine, diketimine of diethylenetriamine. The amines may be used in combination of two or more.

It is desired for the amine-modified epoxy resins to be ring-opened with amines such that they have an amine equivalent value of 0.3 to 4.0 meq/g after ring opening, and particularly 5 to 50% thereof is primary amine group.

The resulting amine-modified epoxy resins have diglycidyl ether moiety containing oxazolidone ring and dicarbonyl moiety containing saturated or non-saturated hydrocarbon group. The content of the diglycidyl ether moiety containing oxazolidone ring in the amine-modified epoxy resin is within the range of preferably 30 to 70% by weight, more preferably 40 to 60% by weight. The content of the dicarbonyl moiety containing saturated or non-saturated hydrocarbon group in the amine-modified epoxy resin is within the range of preferably 3 to 17% by weight, more preferably 6 to 14% by weight.

The amine-modified epoxy resin having diglycidyl ether moiety containing oxazolidone ring and dicarbonyl moiety containing saturated or non-saturated hydrocarbon group will be schematically explained with the following formula. 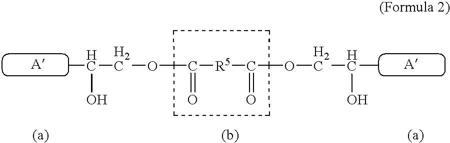
wherein (a) is diglycidyl ether moiety containing oxazolidone ring; [A′] is diglycidyl ether moiety containing oxazolidone ring, in which the epoxy ring contained in the [A] of the above reaction formula (4) is amine-modified; and (b) is dicarbonyl moiety containing saturated or non-saturated hydrocarbon group.

As the second embodiment, the cationic electrodeposition coating composition of the present invention comprises a binder resin emulsion comprising

a binder resin formed from (a) an amine-modified bisphenol type epoxy resin having an amino group; and (b) a blocked isocyanate curing agent; and

an emulsion resin formed from (c) a modified epoxy resin having a quaternary ammonium group.

(a) Amine-Modified Bisphenol Type Epoxy Resin

The (a) amine-modified bisphenol type epoxy resin used in the present invention is bisphenol type epoxy resin modified with amine. The (a) amine-modified bisphenol type epoxy resin is typically prepared by opening all of the epoxy rings of the bisphenol type epoxy resin with amine, or by opening a portion of the epoxy rings with additional active hydrogen compound and opening the rest of the epoxy rings with amine.

The concrete examples of the bisphenol type epoxy resins include bisphenol A type epoxy resins and bisphenol F type epoxy resins. Examples of the bisphenol A type epoxy resins, which are commercially available from Yuka Shell Epoxy Co., Ltd., include Epikote 828 (epoxy equivalent: 180 to 190), Epikote 1001 (epoxy equivalent: 450 to 500), Epikote 1010 (epoxy equivalent: 3,000 to 4,000) and the like. Examples of the bisphenol F type epoxy resins, which are commercially available from Yuka Shell Epoxy Co., Ltd., include Epikote 807 (epoxy equivalent: 170) and the like.

The epoxy resin containing oxazolidone ring represented by the following formula: 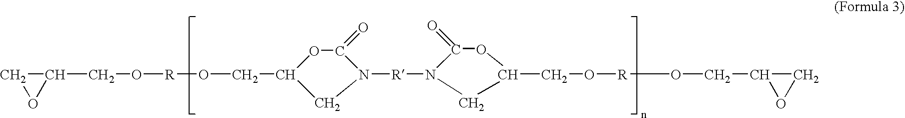
wherein R represents a residual group obtained by removing glycidyloxy group from diglycidyl epoxy compound, R′ represents a residual group obtained by removing isocyanate group from diisocyanate compound, and n represents a positive integer,
disclosed in Japanese Patent Kokai Publication No. 306327/1993 may be used as (a) the amine-modified bisphenol type epoxy resin, because of obtaining a coated film having excellent heat resistance and excellent corrosion resistance.

A method of introducing the oxazolidone ring into the epoxy resin includes a method comprising the steps of heating the blocked isocyanate curing agent blocked with lower alcohol such as methanol and polyepoxide under basic catalyst and keeping the temperature constant, and distilling the lower alcohol as a by-product off the system.

The particularly preferred epoxy resin is oxazolidone ring containing epoxy resin. This is because the coated film, which is superior in heat resistance, corrosion resistance and impact resistance, can be obtained.

It is well known to obtain epoxy resins containing oxazolidone ring by reaction of bifunctional epoxy resin with diisocyanate blocked with monoalcohol (that is, bisurethane). The concrete examples of the oxazolidone ring containing epoxy resins and the preparing method thereof are disclosed in paragraphs [0012] to [0047] of Japanese Patent Kokai Publication No. 128959/2000, which are well known.

The epoxy resins may be modified with suitable resins, such as polyester polyol, polyether polyol, and monofuctional alkylphenol. In addition, the epoxy resins can be chain-extended by the reaction of epoxy group with diol or dicarboxylic acid.

It is desired for the epoxy resins to be ring-opened with active hydrogen compound such that they have an amine equivalent value of 0.3 to 4.0 meq/g after ring opening, and particularly 5 to 50% thereof is primary amine group.

Examples of the amines for the reaction with the epoxy group in the bisphenol type epoxy resin include primary amine and secondary amine. An amine-modified bisphenol type epoxy resin having tertiary amino group can be obtained by the reaction of bisphenol type epoxy resin and secondary amine. An amine-modified bisphenol type epoxy resin having secondary amino group can be obtained by the reaction of bisphenol type epoxy resin and primary amine. An amine-modified bisphenol type epoxy resin having primary amino group can be prepared by using the amine-modified bisphenol type epoxy resin having primary amino group and secondary amino group. The amine-modified bisphenol type epoxy resin having primary amino group and secondary amino group can be prepared by blocking the primary amino group with ketone to form ketimine before the reaction with epoxy resin, and then introducing the ketimine into the epoxy resin to deblocking it.

Concrete examples of the primary amines, secondary amines and ketimines include butylamine, octylamine, diethylamine, dibutylamine, methylbutylamine, monoethanolamine, diethanolamine, N-methylethanolamine; and secondary amines having blocked primary amines, such as ketimine of aminoethylethanolamine, diketimine of diethylenetriamine. The amines may be used in combination of two or more.

The (a) amine-modified bisphenol type epoxy resin can be prepared with primary amine and/or secondary amine as described above. Examples of the amino groups contained in the resin (a) include primary amino group, secondary amino group and tertiary amino group, and the resin (a) has at least one of the amino groups.

Emulsion Resin Formed from (c) a Modified Epoxy Resin having a Quaternary Ammonium Group

The emulsion resin formed from (c) the modified epoxy resin having a quaternary ammonium group used in the present invention is the resin that assists to emulsify the binder resin. The binder resin is formed from (a) an amine-modified bisphenol type epoxy resin; and (b) a blocked isocyanate curing agent.

The modified epoxy resin having a quaternary ammonium group is formed by the reaction of epoxy resin with tertiary amine.

As the epoxy resin, polyepoxide, which has two or more 1,2-epoxy groups on the average in a molecular may be generally used. Useful examples of the polyepoxides include the bisphenol type epoxy resin described above. In addition, the epoxy resin containing oxazolidone ring may be used as the epoxy resin.

In case of the epoxy resin having hydroxyl group, urethane-modified epoxy resin formed by reacting the hydroxyl group thereof with half blocked isocyanate to introduce blocked isocyanate group may be used.

The half blocked isocyanate used for reacting with the epoxy resin is prepared by partially blocking organic polyisocyanate. It is preferable to conduct the reaction of the organic polyisocyanate with a blocking agent by dropping the blocking agent with stirring optionally in the presence of tin-based catalyst and cooling to 40 to 50° C.

The polyisocyanate is not limited as long as it has two or more isocyanate groups on the average in a molecular. As concrete examples thereof, the polyisocyanates, which can be used for the preparation of the blocked isocyanate curing agent described later, can be used.

Examples of the blocking agents suitable for preparing the half blocked isocyanate include lower aliphatic alkyl monoalcohols. Concrete examples thereof include butyl alcohol, amyl alcohol, hexyl alcohol, 2-ethylhexyl alcohol, heptyl alcohol and the like.

The reaction of the epoxy resin with half blocked isocyanate may be conducted by keeping the temperature of preferably 140° C. for about 1 hour.

The tertiary amine preferably has 1 to 6 carbon atoms and may have hydroxyl group. Concrete examples of the tertiary amines, as the same as the tertiary amine used as described above, include dimethylethanolamine, trimethylamine, triethylamine, dimethylbenzylamine, diethylbenzylamine, N,N-dimethylcyclohexylamine, tri-n-butylamine, diphenethylmethylamine, dimethylaniline, N-methylmorpholine and the like.

Examples of the acids for neutralization used by mixing with the tertiary amine are not limited, but include inorganic acids, such as hydrochloric acid, nitric acid, phosphoric acid, formic acid, acetic acid, lactic acid, or organic acids and the like. The reaction of the salt of tertiary amine and acid for neutralization with epoxy resin can conduct by conventional methods, for example, comprising the steps of dissolving the epoxy resin in solvent, such as ethylene glycol monobutylether, heating the solution to 60 to 100° C., dropping the salt of tertiary amine and acid for neutralization, and keeping the reaction mixture at 60 to 100° C. such that the acid value is 1.

The emulsion resin (c) of the present invention (2) has an epoxy equivalent of preferably 1,000 to 1,800, more preferably 1,200 to 1,700. When the epoxy equivalent of the emulsion resin is higher than 1,800, the emulsifying performance of the emulsion resin is degraded. On the other hand, when the epoxy equivalent of the emulsion resin is lower than 1,000, the electrical conductivity of the resulting electrodeposition coating composition is high, which degrades the performance of restraining the occurrence of gas pin hole.

It is preferable for the emulsion resin (c) to have a number molecular weight of 1,500 to 2,700.

The emulsion resin (c) of the present invention (2) has 35 to 70 meq, preferably 35 to 55 meq of the quaternary ammonium group, based on 100 g of the emulsion resin (c). When the amount of the quaternary ammonium group is larger than 70 meq, the electrical conductivity of the resulting electrodeposition coating composition is high, which degrades the performance of restraining the occurrence of gas pin hole. On the other hand, when the amount of the emulsion resin (c) is smaller than 35 meq, the emulsifying performance is degraded.

In the present invention, the electrodeposition coating composition having high throwing power and excellent performance of restraining the occurrence of gas pin hole can be accomplished by adjusting the molecular weight and the amount (meq) of the quaternary ammonium group to the above range.

Blocked Isocyanate Curing Agent

Polyisocyanate used for preparing the blocked isocyanate curing agent of the present invention is a compound having at least two isocyanate groups in the molecular. The polyisocyanates may be aliphatic, cycloaliphatic, aromatic or aromatic-aliphatic.

Examples of the polyisocyanates include aromatic diisocyanates, such as tolylene diisocyanate (TDI), diphenylmethane diisocyanate (MDI), p-phenylene diisocyanate and naphthalene diisocyanate; aliphatic diisocyanates having 3 to 12 carbon atoms, such as hexamethylene diisocyanate (HDI), 2,2,4-trimethylhexane diisocyanate and lysine diisocyanate; cycloaliphatic diisocyanates having 5 to 18 carbon atoms, such as 1,4-cyclohexane diisocyanate, isophorone diisocyanate (IPDI), 4,4′-dicyclohexylmethane diisocyanate (hydrogenated MDI), methylcyclohexane diisocyanate, isopropylidenedicyclohexyl-4,4′-diisocyanate and 1,3-diisocyanatomethylcyclohexane (hydrogenated XDI), hydrogenated TDI, 2,5- or 2,6-bis(isocyanate methyl)-bicyclo[2.2.1]heptane (=norbornane diisocyanate); aliphatic diisocyanates having aromatic ring, such as xylylene diisocyanate (XDI) and tetramethylxylylene diisocyanate (TMXDI); modified compounds thereof (urethane compound, carbodiimide, urethodion, urethonimine, biuret and/or isocyanurate modified compound); and the like. The polyisocyanate may be used alone or in combination of two or more.

Adducts or prepolymers obtained by reacting the polyisocyanate with polyalcohols, such as ethylene glycol, propylene glycol, trimethylolpropane and hexanetriol at a NCO/OH ratio of not less than 2 may be used as the blocked isocyanate curing agent.

The blocking agent is adducted to the isocyanate group of the polyisocyanate and stable at room temperature, but free isocyanate group can be regenerated by deblocking when heating it at the temperature not less than the dissociation temperature.

As the blocking agent used in the present invention, ε-caprolactam, butyl cellosolve and the like, which have been conventionally used in the art.

(d) Amine-Modified Novolac Type Epoxy Resin

In the present invention, (d) the amine-modified novolac type epoxy resin, which optionally may be used, may be typically prepared by opening the epoxy ring of the novolac type epoxy resin with amine. Examples of the novolac type epoxy resins include novolac type epoxy resins represented by the following formula: 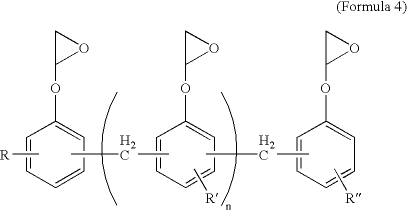
wherein R, R′ and R″ are independently hydrogen or linear or blanched alkylene having 1 to 5 carbon atoms, and repeating unit n is 0 to 25.

Typical examples of the novolac type epoxy resins include phenol novolac type epoxy resins or cresol novolac type epoxy resins. Examples of the phenol novolac type epoxy resins include YDPN-638, which is commercially available from Tohto Kasei Co., Ltd. and the like, and examples of the cresol novolac type epoxy resins include YDCN-701, YDCN-704, which are commercially available from Tohto Kasei Co., Ltd. and the like.

The amines for the reaction with the epoxy group of the novolac type epoxy resins include primary amine, secondary amine. Among the amines, particularly preferred is secondary amine. An amine-modified epoxy resin having tertiary amino group is obtained by the reaction of epoxy resin with secondary amine.

Concrete examples of the amines include butylamine, octylamine, diethylamine, dibutylamine, methylbutylamine, monoethanolamine, diethanolamine, N-methylethanolamine; and secondary amines having blocked primary amines, such as ketimine of aminoethylethanolamine, diketimine of diethylenetriamine. The amines may be used in combination of two or more. The reaction of epoxy resins with amines is disclosed in Japanese Patent Kokai Publication Nos. 306327/1993 and 128959/2000, which is well known.

Moreover, carboxylic acids such as acetic acid, alcohols such as allyl alcohol, phenols such as nonyl phenol and the like may be add to a portion of epoxy rings in the novolac type epoxy resin.

It is preferable for the (d) amine-modified novolac type epoxy resin to be used in an amount of 0.1 to 5.0 parts by weight, based on 100 parts by weight of solid content of the binder resin contained in the electrodeposition coating composition. The lower limit of the amount of the epoxy resin is more preferably 0.5 parts by weight, further preferably 1.0 part by weight. The upper limit of the amount of the epoxy resin is more preferably 4.5 parts by weight, further preferably 4.0 parts by weight. In this case, it is possible to reduce the occurrence of the gas pin hole and crater, even if the zinc galvanized steel sheet is used as a material to be coated, and the congeniality to the zinc galvanized steel sheet of the resulting electrodeposition coating composition can be further improved. In addition, when the electrodeposition coating is conducted for a short time, it is possible to ensure high throwing power.

The amine-modified novolac type epoxy resin may be used after neutralizing by acid for neutralization. The amount of the acid for neutralization is not limited. The acid for neutralization is preferably used in at least the minimum amount such that it can be stably dispersed in aqueous medium, but it can vary depending on the type of the amine to be added and the type of the acid for neutralization. The amine-modified novolac type epoxy resin can adjust the electrical conductivity of the cationic electrodeposition coating composition to the optimum range that the throwing power is high, while maintaining the congeniality to the zinc galvanized steel sheet.

Pigment

The electrodeposition coating composition of the present invention may contain pigment, which has been conventionally used for a coating. Examples of the pigments include inorganic pigments, for example, a coloring pigment, such as titanium dioxide, carbon black and colcothar; an extender pigment, such as kaolin, talc, aluminum silicate, calcium carbonate, mica and clay; a rust preventive pigment, such as zinc phosphorate, iron phosphorate, aluminum phosphorate; calcium phosphorate, zinc phosphite, zinc cyanide, zinc oxide, aluminum tripolyphosphorate, zinc molybdate, aluminum molybdate, calcium molybdate, aluminum phosphomolybdate and aluminum zinc phosphomolybdate.

If used, it is preferable for the amount of the pigment to be not more than 30% by weight, preferably 1 to 25% by weight, based on the solid content of the coating in the electrodeposition coating composition. When the amount of the pigment is larger than 30% by weight, the horizontal appearance of the resulting electrodeposition coated film is degraded.

When the pigment is used as a component of the electrodeposition coating, the pigment is generally pre-dispersed in an aqueous medium at high concentration in the form of a paste (pigment dispersed paste). This is because it is difficult to uniformly disperse the pigment, which is powdery, at low concentration in one step. The paste is generally called as pigment dispersed paste.

The pigment dispersing paste is prepared by dispersing the pigment together with pigment dispersing resin varnish in an aqueous medium. As the pigment dispersing resin, cationic or non-ionic low molecular weight surfactant, or cationic polymer such as modified epoxy resin having quaternary ammonium group and/or tertiary sulfonium group can be used. As the aqueous medium, deionized water or water containing a small amount of alcohol can be used.

The pigment dispersing resin is generally used at the solid content of 20 to 100 parts by weight based on 100 parts by weight of the coating. The pigment dispersing paste can be obtained by mixing the pigment dispersing resin varnish with the pigment, and dispersing the pigment using a suitable dispersing apparatus, such as a ball mill or sand grind mill.

The cationic electrodeposition coating composition may optionally contains dissociation catalyst, organic tin compounds, such as dibutyltin dilaurate, dibutyltin oxide, dioctyltin oxide; amines, such as N-methyl morpholine; metal salts of strontium, cobalt and supper; in order to dissociate the blocking agent in addition to the above components. The amount of the dissociation catalyst is preferably from 0.1 to 6 parts by weight based on 100 parts by weight of the solid content of the binder resin in the electrodeposition coating composition.

Preparation of Lead-Free Cationic Electrodeposition Coating Composition (in the First Embodiment)

The lead-free cationic electrodeposition coating composition of the present invention is prepared by dispersing the above amine-modified epoxy resin, blocked isocyanate curing agent, pigment dispersed paste and catalyst in an aqueous medium. In addition, the aqueous medium may contain an acid for neutralization in order to neutralize the cationic epoxy resin to improve the dispersibility of binder resin emulsion. Examples of the acid for neutralization include inorganic acids or organic acids, such as hydrochloric acid, nitric acid, phosphoric acid, formic acid, acetic acid, lactic acid, sulfamic acid, acetyl glycine and the like. The aqueous medium as used herein is water or a mixture of water with organic solvent. It is preferable to use deionized water as the water. Examples of the organic solvents used include hydrocarbons (such as xylene or toluene), alcohols (such as methyl alcohol, n-butyl alcohol, isopropyl alcohol, 2-ethylhexyl alcohol, ethylene glycol, propylene glycol), ethers (such as ethylene glycol monoethylether, ethylene glycol monobutylether, ethylene glycol monohexylether, propylene glycol monoethylether, 3-methyl-3-methoxybutanol, diethylene glycol monoethylether, diethylene glycol monobutylether), ketones (such as methyl isobutyl ketone, cyclohexanone, isophorone, acetyl acetone), esters (such as ethylene glycol monoethylether acetate, ethylene glycol monobutylether acetate) or mixtures thereof.

It is desired for the amount of the blocked isocyanate curing agent to be sufficient to react with active hydrogen containing functional group, such as primary amino group, secondary amino group, and hydroxyl group during curing to provide good cured coated film. The amount of the blocked isocyanate curing agent, which is represented by a solid content ratio of the cationic epoxy resin to the blocked isocyanate curing agent (cationic epoxy resin/curing agent), is within the range of preferably 90/10 to 50/50, more preferably 80/20 to 65/35. The amount of the acid for neutralization is sufficient to neutralize at least 20%, preferably 30 to 60% of the cationic group of the cationic epoxy resin.

The organic solvent is used as a solvent when preparing resin components, such as the cationic epoxy resin, blocked isocyanate curing agent. The complicated procedure is necessary for completely removing the solvent. The flowability of the coated film at the time of film forming is improved by containing the organic solvent in the binder resin, and the smoothness of the coated film is improved. Examples of the organic solvents typically used for coating composition include the organic solvents described above.

In the lead-free cationic electrodeposition coating composition of the present invention, it is desired for the content of the organic solvent to be not more than 0.5%, preferably 0.1 to 0.5%, more preferably 0.1 to 0.4%. The lead-free cationic electrodeposition coating composition of the present invention has various advantages of having low appearance error rate, excellent throwing power and low organic solvent content.

The cationic electrodeposition coating composition can contain additives for a coating, such as a plasticizer, surfactant, antioxidant and ultraviolet absorber, in addition to the above components.

When electrodeposition coated film having a thickness of 15 μm is formed from the lead-free cationic electrodeposition coating composition, it is preferable for the coated film to have a membrane resistance of 1,000 to 1,500 kΩ·cm². The electrodeposition coating composition has excellent throwing power by adjusting the membrane resistance of the electrodeposition coated film to the above range.

Preparation of Electrodeposition Coating Composition (in the Second Embodiment)

The cationic electrodeposition coating composition of the present invention (II) can be prepared by dispersing the binder resin emulsion, and optionally pigment dispersed paste and catalyst in a aqueous medium.

The binder resin emulsion of the present invention (II) comprises

a binder resin formed from (a) an amine-modified bisphenol type epoxy resin having an amino group; and (b) a blocked isocyanate curing agent; and

an emulsion resin formed from (c) a modified epoxy resin having a quaternary ammonium group.

The binder resin emulsion can be prepared by optional methods. The preferable methods include a method comprising the steps of

mixing aqueous medium containing (a) an amine-modified bisphenol type epoxy resin having an amino group; (b) a blocked isocyanate curing agent; (c) a portion of an emulsion resin; and acid for neutralization; to emulsify the emulsion resin (first dilution), and

adding aqueous medium and the rest of the emulsion resin (c) to the mixture to emulsify the emulsion resin (second dilution). The core-shell type binder resin emulsion, of which the shell is formed from the emulsion resin (c), can be obtained. The emulsion has a advantage of having excellent stability if the mount of the acid for neutralization is small.

The binder resin emulsion has a quaternary ammonium group. The emulsifying performance of these emulsions is improved by the quaternary ammonium group. Thereby even if using a small amount of the acid for neutralization, the binder resin emulsion having stable dispersion can be obtained. As the result, the electrical conductivity of the cationic electrodeposition coating composition can be decreased, and it is possible to improve the throwing powder and performance of restraining the occurrence of gas pin hole. In addition, electrodeposition coating by low applied voltage can be conducted, and it is possible to obtain electrodeposition coated film having larger thickness.

The electrodeposition coating composition comprises the acid for neutralization. The acid for neutralization neutralizes the amine-modified bisphenol type epoxy resin to improve the dispersibility of binder resin emulsion. The acid for neutralization is contained in aqueous medium used for preparing the binder resin emulsion. Examples of the acid for neutralization include inorganic acids or organic acids, such as hydrochloric acid, nitric acid, phosphoric acid, formic acid, acetic acid, lactic acid and the like.

When the amount of the acid for neutralization in the coating composition is large, the neutralization ratio of the amine-modified bisphenol type epoxy resin is high, and the affinity of the binder resin emulsion for the aqueous medium is high, which improves the stability of dispersion. It is meant that it is difficult to deposit the binder resin on the material to be coated, which reduces the deposition of the coating solid content.

On the other hand, the amount of the acid for neutralization in the coating composition is small, the neutralization ratio of the amine-modified bisphenol type epoxy resin is low, and the affinity of the binder resin emulsion for the aqueous medium is low, which reduces the stability of dispersion. It is meant that it is easy to deposit the binder resin on the material to be coated, which improves the deposition of the coating solid content.

Therefore, in order to improve the throwing powder of the electrodeposition coating, it is preferable to restrain the neutralization ratio of the amine-modified bisphenol type epoxy resin to low level by reducing the acid for neutralization in the coating composition.

The amount of the acid for neutralization used for preparing the binder resin emulsion is preferably from 10 to 22 mg equivalent, based on 100 g of the solid content of the binder resin emulsion. The solid content of the binder resin emulsion is the solid content of (a) the amine-modified bisphenol type epoxy resin, (b) the blocked isocyanate curing agent and (c) the modified epoxy resin having a quaternary ammonium group. When the amount of the acid for neutralization is smaller than 10 mg equivalent, the affinity for water is not sufficient, and it can not be dispersed in water or the dispersion stability is not sufficiently obtained. On the other hand, when the amount of the acid for neutralization is larger than 22 mg equivalent, the quantity of electricity necessary for the deposition increases, and the deposition of the coating solid content is degraded, which reduces the throwing power.

The amount of the acid for neutralization as used herein means an amount of acid used to neutralize the amine-modified bisphenol type epoxy resin when emulsifying, and it is represented by mg equivalent based on 100 g of the solid content of the binder resin emulsion, which is shown in MEQ(A).

The cationic electrodeposition coating composition comprises an emulsion resin formed from (c) a modified epoxy resin having a quaternary ammonium group in binder resin emulsion. The emulsifying performance of the binder resin is improved by the presence of the quaternary ammonium group. Thereby even if using a small amount of the acid for neutralization, stable binder resin emulsion can be obtained. It is difficult for the quaternary ammonium group in the binder resin emulsion to be substituted for the acid for neutralization, which neutralizes an amino group in amine-modified bisphenol type epoxy resin. Therefore, it is possible to ensure the amino group of the resin to low degree of neutralization, and it is possible to stabilize the binder resin emulsion even if the amount of the acid for neutralization is small.

The cationic electrodeposition coating composition comprising the quaternary ammonium group in the binder resin emulsion has been never prepared. It is for the reason that, if the cationic epoxy resin containing quaternary ammonium group, which is obtained by modifying epoxy resin with tertiary amine, is used as a binder resin, the water solubility of the resin is too high, and the deposition when electrodeposition coating is degraded, which is not suitable for practical use. In the present invention (II), the quaternary ammonium group is contained in the binder resin emulsion in the amount without improving the water solubility of the binder resin and degrading the deposition. It is possible to improve both the throwing power and performance of restraining the occurrence of gas pin hole by preparing the cationic electrodeposition coating composition comprising the quaternary ammonium group in the binder resin emulsion.

Methods of introducing the quaternary ammonium group in the binder resin emulsion in the amount without improving the water solubility of the binder resin and degrading the deposition include a method of adjusting a weight ratio of the solid content of (a) the amine-modified bisphenol type epoxy resin having an amino group and the emulsion resin formed from (c) the modified epoxy resin having a quaternary ammonium group to 98:2 to 70:30, preferably 97:3 to 85:15.

The amount of the blocked isocyanate curing agent should be sufficient to provide good cured coated film by the reaction with active hydrogen containing functional groups, such as primary amino group, secondary amino group, tertiary amino group, hydroxyl group in the amine-modified bisphenol type epoxy resin when curing. Therefore, a weight ratio (epoxy resin/curing agent) of solid content of the amine-modified bisphenol type epoxy resin to the blocked isocyanate curing agent is generally 90/10 to 50/50, preferably 80/20 to 65/35.

The organic solvent is used as a solvent when synthesizing resin components, such as the amine-modified bisphenol type epoxy resin, blocked isocyanate curing agent, pigment dispersing resin. The complicated procedure is necessary for completely removing the solvent. The flowability of the coated film at the time of film forming is improved by containing the organic solvent in the binder resin, and the smoothness of the coated film is improved.

Examples of the organic solvents typically used for coating composition include ethylene glycol monobutyl ether, ethylene glycol monohexyl ether, ethylene glycol monoethylhexyl ether, propylene glycol monobutyl ether, dipropylene glycol monobutyl ether, propylene glycol monophenyl ether and the like. The organic solvent may be contained in the aqueous medium used for preparing the cationic electrodeposition coating composition.

The cationic electrodeposition coating composition can contain additives for a coating, such as a plasticizer, surfactant, antioxidant and ultraviolet absorber, in addition to the above components.

It is preferable for the cationic electrodeposition coating composition to have an electrical conductivity of 1,200 to 1,600 μS/cm. When the electrical conductivity is lower than 1,200 μS/cm, the throwing power is not sufficiently improved. On the other hand, when the electrical conductivity is higher than 1,600 μS/cm, the gas pin hole occurs, which degrades the appearance on the surface of the coated film. The electrical conductivity can be measured by using commercially available electrical conductivity meter according to JIS K 0130 (General rules for electrical conductivity measuring method).

The cationic electrodeposition coating composition having the above range of the electrical conductivity can be obtained by using the binder resin emulsion to introduce the quaternary ammonium group in the binder resin emulsion, or by using (d) the amine-modified novolac type epoxy resin when preparing the binder resin emulsion.

Method of Coating Cationic Electrodeposition Coating Composition

The lead-free cationic electrodeposition coating composition is electrodeposition coated on the material to be coated to form the coated film. Examples of the materials to be coated are not limited, but include iron plate, steel plate, aluminum plate, and the surface treated articles thereof, the molded articles thereof and the like.

Electrodeposition coating is carried out by applying a voltage of usually 50 to 450 V between the material to be coated serving as cathode and anode. When the applied voltage is lower than 50 V, the electrodeposition becomes insufficient. On the other hand, when the applied voltage is higher than 450 V, the coated film may be broken and appearance thereof becomes unusual. When electrodeposition coating, the electrodeposition bath temperature of the coating composition is usually controlled to 10 to 45° C.

The electrodeposition process of the cation electrodeposition coating composition comprises the steps of immersing a material to be coated, and applying a voltage between the material to be coated as cathode and anode to cause deposition of coated film. Also, the period of time for applying the voltage can be generally 2 to 4 minutes, though it varies with the electrodeposition condition. The term “electrodeposition coated film” as used herein refers to an uncured coated film after electrodeposition coating, when it is after the deposition of coated film and before baking and curing.

The thickness of the electrodeposition coated film is 5 to 80 μm, preferably 5 to 25 μm, more preferably 15 to 25 μm. When the thickness is smaller than 5 μm, rust resistance is not sufficiently obtained. It is desired for the electrodeposition coated film having a thickness of 15 μm to have a membrane resistance of 900 to 1, 600 kΩ·cm², preferably 1,000 to 1,500 kΩ·cm². When the membrane resistance is lower than 900 kΩ·cm², it is the state such that the electrical resistance is not sufficiently obtained, which degrades the throwing power. On the other hand, when the membrane resistance is higher than 1,600 kΩ·cm², the appearance of the coated film is degraded.

The membrane resistance is determined by the following formula:
Membrane resistance value (FR)=VC/A
wherein V is finished coating voltage, A is residual current value of the coated film, and C is coated area (cm²).

The electrodeposition coated film obtained in the manner as described above is baked at a temperature of 120 to 260° C., preferably 140 to 220° C. for 10 to 30 minutes to be cured directly or after being washed with water after completion of the electrodeposition process, thereby the cured electrodeposition coated film is formed.

### EXAMPLES

The present invention will be further explained in detail in accordance with the following examples, however, the present invention is not limited to these examples. In the examples, “part” is based on weight unless otherwise specified.

### Preparation Example 1

Preparation of Blocked Polyisocyanate Curing Agent (in the First and Second Embodiments)

1250 parts of diphenylmethane diisocyanate and 266.4 parts of methyl isobutyl ketone (hereinafter, referred to as MIBK) were loaded to a reaction vessel, and 2.5 parts of dibutyltin dilaurate were added thereto after heating to 80° C. A solution of 226 parts of ε-caprolactam dissolved in 944 parts of butyl cellosolve was dropped thereto at 80° C. over 2 hours. The reaction was retained at 100° C. for 4 hours, it was confirmed that absorption based on an isocyanate group disappeared in IR spectrum measurement, and left to be cooled. 336.1 parts of MIBK were added and thereby, a blocked isocyanate curing agent having a glass transition temperature of 8° C. was obtained.

### Preparation Example 2

Preparation of Amine-Modified Epoxy Resin (in the First Embodiment)

35 parts of 2,4-/2,6-tolylenediisocyanate (weight ratio=8/2), 50 parts of MIBK and 0.5 part of dibutyltin dilaurate were loaded to a flask equipped with a stirrer, a condenser, a nitrogen introducing tube, a thermometer and a dropping funnel. 7 parts of methanol was added while stirring the reaction mixture. Starting at room temperature, the reaction mixture was allowed to rise to 60° C. by exothermic, the reaction was retained for 30 minutes, and 12 parts of ethylene glycol mono-2-ethylhexyl ether was dropped from the dropping funnel. Furthermore, 33 parts of bisphenol A-propylene oxide 5 mol adduct was added. The reaction was carried out mainly in the temperature range of 60 to 65° C., and continued until absorption based on an isocyanate group disappeared in IR spectrum measurement. Next, 383 parts of epoxy resin of epoxy equivalent 188 synthesized from bisphenol A and epichlorohydrin in accordance with a known method was added to the reaction mixture and heated to 125° C. After that, 1.0 part of benzyldimetylamine was added and allowed to react at 130° C. until epoxy equivalent became 266.

Subsequently, 90 parts of bisphenol A, 47 parts of octylic acid and 71 parts of dimeric acid were added and allowed to react at 120° C. to achieve epoxy equivalent of 1460.

Thereafter, the reaction mixture was cooled, and 31 parts of diethanolamine and 39 parts of 79% by weight solution in MIBK of ketimined aminoethyl ethanolamine were added, and was allowed to react for 2 hours at 110° C. Then, the reaction mixture was diluted with MIBK until nonvolatile solid content became 88%, and an amine-modified epoxy resin was obtained. The resulting amine-modified epoxy resin had a number average molecular weight (GPC) of 1,750, a glass transition temperature Tg of 25.1° C., an amine equivalent of 82 meq/100 g, and a content of saturated or non-saturated hydrocarbon group containing dicarbonyl moiety of 8% by weight.

The Tg of the amine-modified epoxy resin and blocked isocyanate curing agent was measured with DSC (Differential Scanning Calorimeter), manufactured by Seiko Instruments Inc.

### Preparation Example 3

Preparation of Amine-Modified Epoxy Resin

35 parts of 2,4-/2,6-tolylenediisocyanate (weight ratio=8/2), 94 parts of MIBK and 0.5 part of dibutyltin dilaurate were loaded to a flask equipped with a stirrer, a condenser, a nitrogen introducing tube, a thermometer and a dropping funnel. 7 parts of methanol was added while stirring the reaction mixture. Starting at room temperature, the reaction mixture was allowed to rise to 60° C. by exothermic, the reaction was retained for 30 minutes, and 12 parts of ethylene glycol mono-2-ethylhexyl ether was dropped from the dropping funnel. Furthermore, 33 parts of bisphenol A-propylene oxide 5 mol adduct was added. The reaction was carried out mainly in the temperature range of 60 to 65° C., and continued until absorption based on an isocyanate group disappeared in IR spectrum measurement. Next, 383 parts of epoxy resin of epoxy equivalent 188 synthesized from bisphenol A and epichlorohydrin in accordance with a known method was added to the reaction mixture and heated to 125° C. After that, 1.0 part of benzyldimetylamine was added and allowed to react at 130° C. until epoxy equivalent became 266.

Subsequently, 74 parts of bisphenol A, 46 parts of octylic acid and 102 parts of dimeric acid were added and allowed to react at 120° C. to achieve epoxy equivalent of 1500.

Thereafter, the reaction mixture was cooled, and 30 parts of diethanolamine and 38 parts of 79% by weight solution in MIBK of ketimined aminoethyl ethanolamine were added, and was allowed to react for 2 hours at 110° C. Then, the reaction mixture was diluted with MIBK until nonvolatile solid content became 88%, and an amine-modified epoxy resin was obtained. The resulting amine-modified epoxy resin had a number average molecular weight (GPC) of 1,800, a glass transition temperature Tg of 21.9° C., an amine equivalent of 82 meq/100 g, a content of oxazolidone ring of 52% by weight, and a content of saturated or non-saturated hydrocarbon group containing dicarbonyl moiety of 12% by weight.

### Preparation Example 4

Preparation of Pigment Dispersing Resin Varnish

A reaction vessel equipped with a stirrer, a condenser, a nitrogen introducing tube, a thermometer and a dropping funnel was charged with 382.20 parts of bisphenol A type epoxy resin having an epoxy equivalent of 188 (Trade name “DER-331J”) and 111.98 parts of bisphenol A, and 1.53 parts of 1% solution of 2-ethyl-4-methyl imidazole was added thereto after heating to 80° C. and uniformly dissolving to react at 170° C. for 2 hours. After cooling to 140° C., 196.50 parts of isophorone diisocyanate half-blocked with 2-ethylhexanol (nonvolatile solid content of 90% by weight) was added to react until NCO group disappeared. It was then charged with 205.00 parts of dipropylene glycol monobutyl ether, 408.00 parts of 1-(2-hydroxyethylthio)-2-propanol, 134.00 parts of dimethylol propionic acid and 144.00 parts of ion-exchanged water to react at 70° C. The reaction was continued until the acid value is not more than 5. The resulting resin varnish was diluted with 1150.50 parts of ion-exchanged water until nonvolatile solid content became 35%.

### Preparation Example 5

Preparation of Pigment Dispersing Paste

The pigment dispersing resin varnish of Preparation Example 4 of 120 parts, 2.0 parts of carbon black, 100.0 parts of kaolin, 72.0 parts of titanium dioxide, 8.0 parts of dibutyltin oxide, 18.0 parts of aluminum phosphomolybdate and 184 parts of ion-exchanged water were added in a sand grinding mill, and dispersed until the particle size was 10 μm or less to obtain a pigment dispersing paste having a solid content of 48% by weight.

### Preparation Example 6

Preparation of Blocked Polyisocyanate Curing Agent

168 parts of hexamethylene diisocyanate and 73 parts of MIBK were loaded to a reaction vessel, and 0.2 parts of dibutyltin dilaurate were added thereto after heating to 80° C. A solution of 34.6 parts of trimethylolpropane dissolved in 50 parts of MIBK was dropped thereto at 60° C. over 2 hours. 106.7 parts of methylethyl ketoxime was dropped over 2 hours after heating to 70° C. It was confirmed that absorption based on an isocyanate group disappeared in IR spectrum measurement, and left to be cooled. 59.4 parts of MIBK were added and thereby, a blocked isocyanate curing agent having a glass transition temperature Tg of −20° C. was obtained.

### Preparation Example 7

Preparation of Amine-Modified Epoxy Resin Emulsion without Dicarbonyl Moiety

38 parts of 2,4-/2,6-tolylenediisocyanate (weight ratio=8/2), 93 parts of MIBK and 0.5 part of dibutyltin dilaurate were loaded to a flask equipped with a stirrer, a condenser, a nitrogen introducing tube, a thermometer and a dropping funnel. 7 parts of methanol was added while stirring the reaction mixture. Starting at room temperature, the reaction mixture was allowed to rise to 60° C. by exothermic, the reaction was retained for 30 minutes, and 13 parts of ethylene glycol mono-2-ethylhexyl ether was dropped from the dropping funnel. Furthermore, 35 parts of bisphenol A-propylene oxide 5 mol adduct was added. The reaction was carried out mainly in the temperature range of 60 to 65° C., and continued until absorption based on an isocyanate group disappeared in IR spectrum measurement. Next, 406 parts of epoxy resin of epoxy equivalent 188 synthesized from bisphenol A and epichlorohydrin in accordance with a known method was added to the reaction mixture and heated to 125° C. After that, 1.0 part of benzyldimetylamine was added and allowed to react at 130° C. until epoxy equivalent became 266.

Subsequently, 125 parts of bisphenol A and 50 parts of octylic acid were added and allowed to react at 120° C. to achieve epoxy equivalent of 1370. Thereafter, the reaction mixture was cooled, and 33 parts of diethanolamine and 41 parts of 79% by weight solution in MIBK of ketimined aminoethyl ethanolamine were added, and were allowed to react for 2 hours at 110° C. Then, the reaction mixture was diluted with MIBK until nonvolatile solid content became 88%, and an amine-modified epoxy resin was obtained. The resulting amine-modified epoxy resin had a number average molecular weight (GPC) of 1,650, a glass transition temperature Tg of 38.7° C., an amine equivalent of 87 meq/100 g and a content of oxazolidone ring in the amine-modified epoxy resin of 57% by weight.

The amine-modified epoxy resin obtained in Preparation example 7 and the blocked isocyanate curing agent obtained in Preparation example 1 were uniformly mixed in solid content ratio of 70/30. To the mixture glacial acetic acid was added so that milligram equivalent value of acid based on 100 g of the resin solid content MEQ(A) was 30, and ion-exchanged water was slowly added for dilution. MIBK was removed under reduced pressure to obtain an emulsion having a solid content of 36%.

### Preparation Example 8

Preparation of Amine-Modified Epoxy Resin Emulsion Containing Bisphenol A-Ethylene Oxide 5 mol Adduct

36 parts of 2,4-/2,6-tolylenediisocyanate (weight ratio=8/2), 50 parts of MIBK and 0.5 part of dibutyltin dilaurate were loaded to a flask equipped with a stirrer, a condenser, a nitrogen introducing tube, a thermometer and a dropping funnel. 7 parts of methanol was dropped while stirring the reaction mixture. Starting at room temperature, the reaction mixture was allowed to rise to 60° C. by exothermic, the reaction was retained for 30 minutes, and 12 parts of ethylene glycol mono-2-ethylhexyl ether was dropped from the dropping funnel. Furthermore, 34 parts of bisphenol A-propylene oxide 5 mol adduct was added. The reaction was carried out mainly in the temperature range of 60 to 65° C., and continued until absorption based on an isocyanate group disappeared in IR spectrum measurement. Next, 406 parts of epoxy resin of epoxy equivalent 188 synthesized from bisphenol A and epichlorohydrin in accordance with a known method was added to the reaction mixture and heated to 125° C. After that, 1.0 part of benzyldimetylamine was added and allowed to react at 130° C. until epoxy equivalent became 266.

Subsequently, 87 parts of bisphenol A, 47 parts of octylic acid and 68 parts of bisphenol A-ethylene oxide 5 mol adduct were added and allowed to react at 120° C. to achieve epoxy equivalent of 1450. Thereafter, the reaction mixture was cooled, and 31 parts of diethanolamine and 39 parts of 79% by weight solution in MIBK of ketimined aminoethyl ethanolamine were added, and were allowed to react for 2 hours at 110° C. Then, the reaction mixture was diluted with MIBK until nonvolatile solid content became 88%, and an amine-modified epoxy resin was obtained. The resulting amine-modified epoxy resin had a number average molecular weight (GPC) of 1,740, a glass transition temperature Tg of 36.2° C., an amine equivalent of 83 meq/100 g and a content of oxazolidone ring in the amine-modified epoxy resin of 54% by weight.

The amine-modified epoxy resin obtained in Preparation example 8 and the blocked isocyanate curing agent obtained in Preparation example 1 were uniformly mixed in solid content ratio of 70/30. To the mixture glacial acetic acid was added so that milligram equivalent value of acid based on 100 g of the resin solid content MEQ(A) was 30, and ion-exchanged water was slowly added for dilution. MIBK was removed under reduced pressure to obtain an emulsion having a solid content of 36%.

### Preparation Example 9

Preparation of Amine-Modified Bisphenol a Type Epoxy Resin Having Amino Group (a) (in the Second Embodiment)

92 parts of 2,4-/2,6-tolylenediisocyanate (weight ratio=8/2), 95 parts of MIBK and 0.5 part of dibutyltin dilaurate were loaded to a flask equipped with a stirrer, a condenser, a nitrogen introducing tube, a thermometer and a dropping funnel. 21 parts of methanol was dropped while stirring the reaction mixture. Starting at room temperature, the reaction mixture was allowed to rise to 60° C. by exothermic, the reaction was retained for 30 minutes, and 57 parts of ethylene glycol mono-2-ethylhexyl ether was dropped from the dropping funnel. Furthermore, 42 parts of bisphenol A-propylene oxide 5 mol adduct was added. The reaction was carried out mainly in the temperature range of 60 to 65° C., and continued until absorption based on an isocyanate group disappeared in IR spectrum measurement. Next, 365 parts of epoxy resin of epoxy equivalent 188 synthesized from bisphenol A and epichlorohydrin in accordance with a known method was added to the reaction mixture and heated to 125° C. After that, 1.0 part of benzyldimetylamine was added and allowed to react at 130° C. until epoxy equivalent became 410.

Subsequently, 61 parts of bisphenol A and 33 parts of octylic acid were added and allowed to react at 120° C. to achieve epoxy equivalent of 1190. Thereafter, the reaction mixture was cooled, and 11 parts of diethanolamine and 25 parts of 79% by weight solution in MIBK of ketimined aminoethyl ethanolamine were added, and were allowed to react for 2 hours at 110° C. Then, the reaction mixture was diluted with MIBK until nonvolatile solid content became 80%, and an epoxy resin having a tertiary amino group (amine-modified bisphenol type epoxy resin; resin solid content 80%) was obtained.

### Preparation Example 10

Preparation of Amine-Modified Novolac Type Epoxy Resin (d) (in the Second Embodiment)

204 parts of MIBK were loaded to a flask equipped with a stirrer, a condenser, a nitrogen introducing tube and a thermometer, and 204 parts of cresol novolac type epoxy resin YD-CN703 (Tohto Kasei Co., Ltd.; epoxy equivalent 204) were slowly added thereto to dissolve, after heating to 100° C., and 50% solution of the epoxy resin was obtained. 75.1 parts of N-methylethanolamine and 32.2 parts of MIBK were loaded to another flask equipped with a stirrer, a condenser, a nitrogen introducing tube, a thermometer and a dropping funnel, 408 parts of the 50% solution of the epoxy resin obtained above was dropped thereto over 3 hours after heating to 120° C. Thereafter, the reaction was retained for 2 hours. After cooling to 80° C., 88% solution of 24.8 parts of formic acid in 15.9 parts of ion-exchanged water was added, and mixed at 80° C. for 30 minutes. Furthermore, the reaction mixture was diluted with 489.4 parts of deionized water. MIBK was removed under reduced pressure to obtain a water solution of an amine-modified novolac type epoxy resin having a solid content of 34%. The mine-modified novolac type epoxy resin had a number average molecular weight of 1,800, which was measured by GPC.

### Preparation Example 11

Preparation of a Modified Epoxy Resin Having a Quaternary Ammonium Group (c)

89 parts of dimethylethanolamine and 187.2 parts of 50% lactic acid were loaded to a suitable reaction vessel, and the reaction mixture was stirred at 65° C. for half an hour to prepare a quaternarizing agent.

Subsequently 95.8 parts of EPON 829 (bisphenol A type epoxy resin manufactured by Shell Chemical Company, epoxy equivalent 193 to 203), 44.8 parts of bisphenol A, 4.2 parts of octylic acid and 30.5 parts of MIBK were loaded to a suitable reaction vessel. The reaction mixture was heated to 100° C. under nitrogen atmosphere. Subsequently, 0.01 parts of 2-ethyl-4-methyl imidazole was added and allowed to react at 130° C. to achieve epoxy equivalent of 1,650.

To the reaction mixture 31 parts of ethylene glycol monobutyl ether were added, the mixture was cooled to 85 to 95° C., homogenized, and 16.2 parts of the prepared quaternarizing agent was added thereto. After keeping the reaction mixture at 85 to 95° C. such that the acid value is 1, 277 parts of deionized water was added to obtain a modified epoxy resin having a quaternary ammonium group (c)(solid content 30%). The resulting resin (c) had a number average molecular weight of 2,470, and 39.1 meq of the quaternary ammonium group, based on 100 g of the resin (c).

### Preparation Example 12

Preparation of a Modified Epoxy Resin Having a Quaternary Ammonium Group (c)

96.7 parts of EPON 829 (bisphenol A type epoxy resin manufactured by Shell Chemical Company, epoxy equivalent 193 to 203), 40.5 parts of bisphenol A, 5.7 parts of octylic acid and 28.1 parts of MIBK were loaded to a suitable reaction vessel. The reaction mixture was heated to 100° C. under nitrogen atmosphere. Subsequently, 0.01 parts of 2-ethyl-4-methyl imidazole was added and allowed to react at 130° C. to achieve epoxy equivalent of 1,200.

To the reaction mixture 32.7 parts of ethylene glycol monobutyl ether were added, the mixture was cooled to 85 to 95° C., homogenized, and 21.9 parts of the quaternarizing agent prepared in Preparation example 11 was added thereto. After keeping the reaction mixture at 85 to 95° C. such that the acid value is 1, 274 parts of deionized water was added to obtain a modified epoxy resin having a quaternary ammonium group (c)(solid content 30%). The resulting resin (c) had a number average molecular weight of 1,800, and 52.9 meq of the quaternary ammonium group, based on 100 g of the resin (c).

### Preparation Example 13

Preparation of a Modified Epoxy Resin Having a Quaternary Ammonium Group (c)

98.2 parts of EPON 829 (bisphenol A type epoxy resin manufactured by Shell Chemical Company, epoxy equivalent 193 to 203), 33.1 parts of bisphenol A, 8.4 parts of octylic acid and 24 parts of MIBK were loaded to a suitable reaction vessel, and was heated to 100° C. under nitrogen atmosphere. Subsequently, 0.01 parts of 2-ethyl-4-methyl imidazole was added and allowed to react at 130° C. to achieve epoxy equivalent of 800.

To the reaction mixture 35.4 parts of ethylene glycol monobutyl ether were added, the mixture was cooled to 85 to 95° C., homogenized, and 32.1 parts of the quaternarizing agent prepared in Preparation example 11 was added thereto. After keeping the reaction mixture at 85 to 95° C. such that the acid value is 1, 268 parts of deionized water was added to obtain a modified epoxy resin having a quaternary ammonium group (c)(solid content 30%). The resulting resin (c) had a number average molecular weight of 1,200, and 77.5 meq of the quaternary ammonium group, based on 100 g of the resin (c).

### Preparation Example 14

Preparation of a Modified Epoxy Resin Having a Quaternary Ammonium Group (c)

95.4 parts of EPON 829 (bisphenol A type epoxy resin manufactured by Shell Chemical Company, epoxy equivalent 193 to 203), 46.8 parts of bisphenol A, 3.5 parts of octylic acid and 31.6 parts of MIBK were loaded to a suitable reaction vessel, and was heated to 100° C. under nitrogen atmosphere. Subsequently, 0.01 parts of 2-ethyl-4-methyl imidazole was added and allowed to react at 130° C. to achieve epoxy equivalent of 2,000.

To the reaction mixture 30.4 parts of ethylene glycol monobutyl ether were added, the mixture was cooled to 85 to 95° C., homogenized, and 13.4 parts of the quaternarizing agent prepared in Preparation example 11 was added thereto. After keeping the reaction mixture at 85 to 95° C. such that the acid value is 1, 278 parts of deionized water was added to obtain a modified epoxy resin having a quaternary ammonium group (c)(solid content 30%). The resulting resin (c) had a number average molecular weight of 3,000, and 32.4 meq of the quaternary ammonium group, based on 100 g of the resin (c).

### Preparation Example 15

Preparation of a Modified Epoxy Resin Having a Quaternary Ammonium Group (c)

96.4 parts of EPON 829 (bisphenol A type epoxy resin manufactured by Shell Chemical Company, epoxy equivalent 193 to 203), 45.0 parts of bisphenol A, 4.2 parts of octylic acid and 30.6 parts of MIBK were loaded to a suitable reaction vessel, and was heated to 100° C. under nitrogen atmosphere. Subsequently, 0.01 parts of 2-ethyl-4-methyl imidazole was added and allowed to react at 130° C. to achieve epoxy equivalent of 1,650.

To the reaction mixture 31.3 parts of ethylene glycol monobutyl ether was added, the mixture was cooled to 85 to 95° C., homogenized, and 13.4 parts of the quaternarizing agent prepared in Preparation example 11 was added thereto. After keeping the reaction mixture at 85 to 95° C. such that the acid value is 1, 278 parts of deionized water was added to obtain a modified epoxy resin having a quaternary ammonium group (c)(solid content 30%). The resulting resin (c) had a number average molecular weight of 2,470, and 32.4 meq of the quaternary ammonium group, based on 100 g of the resin (c).

### Preparation Example 16

Preparation of Pigment Dispersing Resin

A reaction vessel equipped with a stirrer, a condenser, a nitrogen introducing tube and a thermometer was charged with 740 parts of bisphenol A type epoxy resin having an epoxy equivalent of 190 (Trade name “Epikote 828” commercially available from Yuka Shell Epoxy Co., Ltd.) and 211 parts of bisphenol A were allowed to react at 170° C. for 2 hours under the presence of 48 parts of MIBK and 1.5 parts of benzyldimethylamine to obtain a product having epoxy equivalent of 700. Thereto 244 parts of thiodiethanol, 268 parts of dimethylol propionic acid and 50 parts of ion-exchanged water were added to react at 60° C. for 5 hours. The resulting resin was diluted with ethylene glycol monobutyl ether until solid content became 30%.

### Preparation Example 17

Preparation of Pigment Dispersing Paste

The pigment dispersing resin of Preparation Example 16 of 200.0 parts, 4.0 parts of carbon black, 36.0 parts of kaolin, 150.0 parts of titanium dioxide, 10.0 parts of aluminum phosphomolybdate and 33.3 parts of ion-exchanged water were added in a sand grinding mill, and dispersed until the particle size was 10 μm or less to obtain a pigment dispersing paste having a solid content of 60% by weight.

### Example 1

### In the First Emobodiment

The amine-modified epoxy resin obtained in Preparation example 2 and the blocked isocyanate curing agent obtained in Preparation example 1 were uniformly mixed in solid content ratio of 70/30. To the mixture glacial acetic acid was added so that milligram equivalent value of acid based on 100 g of the resin solid content MEQ(A) was 30, and ion-exchanged water was slowly added for dilution. MIBK was removed under reduced pressure to obtain an emulsion having a solid content of 36%.

2358 parts of this emulsion, 315 parts of the pigment dispersing paste obtained in Preparation example 5 and 2327 parts of ion-exchanged water were mixed to obtain a cationic electrodeposition coating composition having a solid content of 20% by weight.

### Example 2

### In the First Embodiment

The amine-modified epoxy resin obtained in Preparation example 3 and the blocked isocyanate curing agent obtained in Preparation example 1 were uniformly mixed in solid content ratio of 70/30. To the mixture glacial acetic acid was added so that milligram equivalent value of acid based on 100 g of the resin solid content MEQ(A) was 30, and ion-exchanged water was slowly added for dilution. MIBK was removed under reduced pressure to obtain an emulsion having a solid content of 36%.

2358 parts of this emulsion, 315 parts of the pigment dispersing paste obtained in Preparation example 5 and 2327 parts of ion-exchanged water were mixed to obtain a cationic electrodeposition coating composition having a solid content of 20% by weight.

### Example 3

### In the Second Embodiment

The (a) amine-modified epoxy resin having amino group obtained in Preparation example 9 of 573 parts and the blocked isocyanate curing agent (b) obtained in Preparation example 1 of 245 parts were uniformly mixed in solid content ratio of 70/30. To the mixture 3.07 parts of formic acid and 3.38 parts of acetic acid were added and stirred so that milligram equivalent value of acid based on 100 g of the emulsion solid content MEQ(A) was 18, 98 parts of modified epoxy resin having a quaternary ammonium group prepared in Preparation example 11 was added, and ion-exchanged water was slowly added for dilution. In addition, the modified epoxy resin having a quaternary ammonium group obtained in Preparation example 11 of 229 parts was added and stirred. MIBK was removed under reduced pressure to obtain a binder resin emulsion having a solid content of 36%.

To the resulting binder resin emulsion, a water solution of the amino-modified novolac type epoxy resin obtained in Preparation example 10 was added so that the solid content of the amino-modified novolac type epoxy resin was 1.5% by weight based on 100 parts by weight of the solid content of the binder resin. To the resulting mixture of 1,100 parts by weight, 129 parts of pigment dispersing paste obtained in Preparation example 17 of 129 parts was added, and then 1% by weight of dibutyltin oxide based on the resin solid content and ion-exchanged water were added to obtain a cationic electrodeposition coating composition having a solid content of 20% by weight. The electrodeposition coating composition had an electrical conductivity of 1,370 μS/cm. The electrical conductivity as used herein was measured at liquid temperature of 25° C. by using an electrical conductivity meter CM-30S commercially available from TOA electronics Ltd. according to JIS K 0130 (General rules for electrical conductivity measuring method).

### Example 4

The (a) amine-modified epoxy resin having amino group obtained in Preparation example 9 of 573 parts and the blocked isocyanate curing agent (b) obtained in Preparation example 1 of 245 parts were uniformly mixed in solid content ratio of 70/30. To the mixture 3.07 parts of formic acid and 3.38 parts of acetic acid were added and stirred so that milligram equivalent value of acid based on 100 g of the emulsion solid content MEQ (A) was 18, 98 parts of modified epoxy resin having a quaternary ammonium group obtained in Preparation example 12 was added, and then ion-exchanged water was slowly added for dilution. In addition, the modified epoxy resin having a quaternary ammonium group obtained in Preparation example 12 of 229 parts was added and stirred. MIBK was removed under reduced pressure to obtain a binder resin emulsion having a solid content of 36%.

To the resulting binder resin emulsion, a water solution of the amino-modified novolac type epoxy resin obtained in Preparation example 10 was added so that the solid content of the amino-modified novolac type epoxy resin was 1.5% by weight based on 100 parts by weight of the solid content of the binder resin. To the resulting mixture of 1,100 parts by weight, 129 parts of pigment dispersing paste obtained in Preparation example 17 of 129 parts was added, and then 1% by weight of dibutyltin oxide based on the resin solid content and ion-exchanged water were added to obtain a cationic electrodeposition coating composition having a solid content of 20% by weight. The electrodeposition coating composition had an electrical conductivity of 1,550 μS/cm.

### Comparative Example 1

### In the First Embodiment

The amine-modified epoxy resin emulsion without dicarbonyl moiety obtained in Preparation example 7 and the blocked isocyanate curing agent obtained in Preparation example 1 were uniformly mixed in solid content ratio of 70/30. To the mixture glacial acetic acid was added so that milligram equivalent value of acid based on 100 g of the resin solid content MEQ(A) was 30, and ion-exchanged water was slowly added for dilution. MIBK was removed under reduced pressure to obtain an emulsion having a solid content of 36%.

2358 parts of this emulsion, 540 parts of the pigment dispersing paste obtained in Preparation example 5, 2327 parts of ion-exchanged water were mixed to obtain a cationic electrodeposition coating composition having a solid content of 20% by weight was obtained.

### Comparative Example 2

### In the First Embodiment

The amine-modified epoxy resin emulsion without dicarbonyl moiety obtained in Preparation example 7 and the blocked isocyanate curing agent obtained in Preparation example 6 were uniformly mixed in solid content ratio of 70/30. To the mixture glacial acetic acid was added so that milligram equivalent value of acid based on 100 g of the resin solid content MEQ(A) was 30, and ion-exchanged water was slowly added for dilution. MIBK was removed under reduced pressure to obtain an emulsion having a solid content of 36%.

2358 parts of this emulsion, 315 parts of the pigment dispersing paste obtained in Preparation example 5, 2327 parts of ion-exchanged water were mixed to obtain a cationic electrodeposition coating composition having a solid content of 20% by weight was obtained.

### Comparative Example 3

### In the First Embodiment

The amine-modified epoxy resin emulsion containing bisphenol A-ethylene oxide 5 mol adduct obtained in Preparation example 8 and the blocked isocyanate curing agent obtained in Preparation example 1 were uniformly mixed in solid content ratio of 70/30. To the mixture glacial acetic acid was added so that milligram equivalent value of acid based on 100 g of the resin solid content MEQ(A) was 30, and ion-exchanged water was slowly added for dilution. MIBK was removed under reduced pressure to obtain an emulsion having a solid content of 36%.

2358 parts of this emulsion, 315 parts of the pigment dispersing paste obtained in Preparation example 5 and 2327 parts of ion-exchanged water were mixed to obtain a cationic electrodeposition coating composition having a solid content of 20% by weight was obtained.

### Comparative Example 4

### In the Second Embodiment

A cationic electrodeposition coating composition was prepared as described in Example 3 except for replacing the modified epoxy resin having a quaternary ammonium group obtained in Preparation example 11 with the modified epoxy resin having a quaternary ammonium group obtained in Preparation example 13. The electrodeposition coating composition had an electrical conductivity of 1,660 μS/cm.

### Comparative Example 5

### In the Second Embodiment

It was intended to prepare a cationic electrodeposition coating composition as described in Example 3 except for replacing the modified epoxy resin having a quaternary ammonium group obtained in Preparation example 11 with the modified epoxy resin having a quaternary ammonium group obtained in Preparation example 14, but it was not emulsified. Therefore, an electrodeposition coating composition was not obtained.

### Comparative Example 6

### In the Second Embodiment

A cationic electrodeposition coating composition was prepared as described in Example 3 except for replacing the modified epoxy resin having a quaternary ammonium group obtained in Preparation example 11 with the modified epoxy resin having a quaternary ammonium group obtained in Preparation example 15. The electrodeposition coating composition had an electrical conductivity of 1,265 μS/cm.

### Comparative Example 7

### In the Second Embodiment

The (a) amine-modified epoxy resin having amino group obtained in Preparation example 9 of 630 parts and the blocked isocyanate curing agent (b) obtained in Preparation example 1 of 270 parts were uniformly mixed in solid content ratio of 70/30. To the mixture 4.32 parts of formic acid and 6.62 parts of acetic acid were added and stirred so that milligram equivalent value of acid based on 100 g of the emulsion solid content MEQ(A) was 30, and then ion-exchanged water was slowly added for dilution. MIBK was removed under reduced pressure to obtain a binder resin emulsion having a solid content of 36%.

To the resulting binder resin emulsion of 1,100 parts, 129 parts of pigment dispersing paste obtained in Preparation example 17 of 129 parts was added, and then 1% by weight of dibutyltin oxide based on the resin solid content and ion-exchanged water were added to obtain a cationic electrodeposition coating composition having a solid content of 20% by weight. The electrodeposition coating composition had an electrical conductivity of 1,720 μS/cm.

With respect to the cationic electrodeposition coating compositions obtained in Examples and Comparative examples described above, the organic solvent content, membrane resistance of the electrodeposition coated film, throwing power, unevenness of drying, gas pin hole and average particle size of the binder resin emulsion were measured or evaluated. The test methods are as follows.

(Test Method)

Organic Solvent Content

The coating voltage of the electrodeposition coating was adjusted to 200 V at electrodeposition bath temperature of 30° C. by using ethylene glycol monohexylether. The organic solvent content of the adjusted coating was measured by using a gas chromatography (GC; GC-14A commercially available from Shimadzu Corporation).

Membrane Resistance of Electrodeposition Coated Film

In the electrodeposition bath containing the cationic electrodeposition coating composition obtained in Examples and Comparative Examples, the zinc phosphate treated steel plate (JIS G 3141 SPCC-SD, treated with Surfdine SD-2500 commercially available from Nippon Paint Co., Ltd.; Size 70 mm×150 mm, thickness 0.7 mm) was dipped with the electrodeposition coating in a depth of 10 cm. Voltage was applied on the steel plate and increased to 200 V over 30 seconds, and electrodeposition coating was conducted for 150 seconds at the voltage. The coating voltage such that coated film thickness of 15 μm was obtained at the electrodeposition bath temperature of 30° C. and residual current when the electrodeposition coating was finished were measured, and the membrane resistance value was determined by calculation. The results are shown in Table 1 and Table 2.

Throwing Power

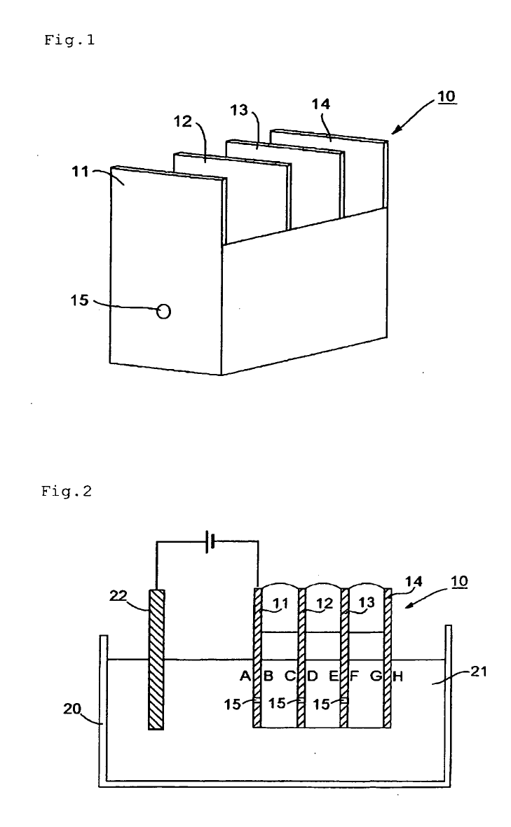

Throwing power was evaluated by a four-plate box method. As shown in FIG. 1, a box 10, which standing four zinc phosphate treated steel sheets 11 to 14 (JIS G 3141 SPCC-SD, treated with Surfdine SD-5000 commercially available from Nippon Paint Co., Ltd.) were parallel positioned at 20 mm apart and the lower portion and bottom portion were closed by an insulator, such as cloth adhesive tape, was prepared. The steel plates 11 to 13 other than the steel plate 14 had a hole 15 having a diameter of 8 mm at the lower portion.

A container of vinyl chloride was charged with 4 L of cationic electrodeposition coating of 4 L, which is a first electrodeposition bath. As shown in FIG. 2, the box 10 was dipped as a material to be coated with the cationic electrodeposition coating 21 in the electrodeposition coating container 20. The coating 21 intrudes into the box 10 only through each hole 15.

The electrodeposition coating was stirred by a magnetic stirrer (not indicated). The steel plates 11 to 14 were electrically connected, and an antipole (anode) 22 was placed at 150 mm from the steel plate 11, which is the nearest from the antipole. Cationic electrodeposition coating was conducted on the steel plates by applying a voltage such that the steel plates 11 to 14 were cathodes and the antipole 22 is an anode. The electrodeposition coating was conducted by increasing the applied voltage until the thickness of the coated film formed on the face A of the steel plate 11 after 5 seconds from the start of applying a voltage is 15 μm; and then maintaining the voltage for 170 seconds in case of normal electrodeposition coating, or for 115 seconds in case of short time electrodeposition coating.

After the coated steel plates were washed with water, baked at 170° C. for 25 minutes and air cooled, the thickness of the coated film formed on the face A of the steel plate 11, which is the nearest from the antipole 22, and the thickness of the coated film formed on the face G of the steel plate 14, which is the farthest from the antipole 22, were measured. The throwing power was determined by calculation of a ratio (G/A value) of the thickness of the coated film formed on the face G to the thickness of the coated film formed on the face A. When the ratio is larger than 60%, the throwing power is high, which is good. On the other hand, when the ratio is not more than 60%, the throwing power is low, which is no good. The results are shown in Table 1 to Table 4.

Unevenness of Drying

In the electrodeposition bath containing the cationic electrodeposition coating composition obtained in Examples and Comparative Examples, the zinc phosphate treated steel plate (JIS G 3141 SPCC-SD, treated with Surfdine SD-2500 commercially available from Nippon Paint Co., Ltd.; Size 70 mm×150 mm, thickness 0.7 mm) was dipped with the electrodeposition coating in a depth of 10 cm. Voltage was applied on the steel plate and increased to 200 V over 30 seconds, and electrodeposition coating was conducted for 150 seconds at the voltage. After electrodeposition coating, the material to be coated drawn up from the electrodeposition bath in the stainless steel container was air dried for 180 seconds above liquid level thereof, washed with water, heated and cured at 170° C. for 25 minutes to prepare a coated plate. The unevenness of drying was evaluated by checking the appearance by visual observation. The evaluation criteria are as follows.

Evaluation Criteria

∘: The unevenness of drying does not occur at all.

Δ: The unevenness of drying slightly occurs.

x: The unevenness of drying significantly occurs.

Gas Pin Hole

In the electrodeposition bath containing the cationic electrodeposition coating composition obtained in Examples and Comparative Examples, alloyed melt galvanized steel plate treated by chemical conversion treatment (Size 70 mm×150 mm, thickness 0.7 mm) was dipped. Voltage was applied on the steel plate and increased to 200 V over 5 seconds, and electrodeposition coating was conducted for 150 seconds at the voltage. After electrodeposition coating, the steel plate was washed with water, baked at 160° C. for 10 minutes to obtain cured electrodeposition coated film. The same operation as described above was repeated after increasing the voltage when electrodeposition coating by every 10 V. The coated surface of the resulting cured electrodeposition coated film was checked by visual observation, and the maximum applied voltage when there is no defect on the coated film was represented by V₂.

In the throwing power test, the voltage when the thickness of the coated film formed on the face A of the steel plate 11 after 5 seconds from the start of applying a voltage is 15 μm is represented by V₁. The value of ΔV is determined by the following formula:
ΔV=V₂−V₁
The gas pin hole was evaluated by the value of ΔV. The larger the value of ΔV is, the better gas pin hole the electrodeposition coating composition has. In addition, it is the electrodeposition coating composition which can correspond to various coating conditions. The results are shown in Table 3 and Table 4.

Average Particle Size of Binder Resin Emulsion

The average particle size of binder resin emulsion in the cationic electrodeposition coating composition obtained in Examples and Comparative Examples was measured by U-1800 commercially available from Hitachi High Technologies Corporation. The results are shown in Table 3 and Table 4.

(Test Results)

TABLE 1

| | Example No. | |
|---|---|---|
| | 1 | 2 |
| Content of diglycidyl ether moiety | 54 | 52 |
| containing oxazolidone ring in | | |
| amine-modified epoxy resin (% by weight) | | |
| Content of dicarbonyl moiety containing | 8 | 12 |
| saturated or non-saturated hydrocarbon | | |
| group in amine-modified epoxy resin (% by weight) | | |
| Tg of amine-modified epoxy resin (° C.) | 25.1 | 21.9 |
| Organic solvent content in electrodeposition | 0.4 | 0.2 |
| coating composition (% by weight) | | |
| Membrane resistance of electrodeposition coated | 1280 | 1340 |
| film (kΩ · cm²) | | |
| Throwing power | 68.0 | 70.3 |
| Unevenness of drying | ∘ | ∘ |

TABLE 2

| | Comparative Example No. | | |
|---|---|---|---|
| | 1 | 2 | 3 |
| Tg of amine-modified epoxy resin (° C.) | 38.7 | 38.7 | 36.2 |
| Organic solvent content in electrodeposition | 1.3 | 0.3 | 1.2 |
| coating composition (% by weight) | | | |
| Membrane resistance of electrodeposition | 920 | 1250 | 950 |
| coated film (kΩ · cm²) | | | |
| Throwing power | 53.7 | 67.1 | 55.8 |
| Unevenness of drying | ∘ | Δ | ∘ |

TABLE 3

Example No.

| | 3 | 4 |
|---|---|---|
| Epoxy equivalent of emulsion resin (c) | 1650 | 1200 |
| Quaternary ammonium group per 100 g of | 39.1 | 52.9 |
| emulsion resin (c) (meq) | | |
| Amount of amine-modified novolac type | 1.5 | 1.5 |
| epoxy resin (solid content) | | |
| Electrical conductivity of electrodeposition | 1370 | 1550 |
| coated film (μS/cm) | | |
| Membrane resistance of electrodeposition | 1410 | 1420 |
| coated film (kΩ · cm²) | | |
| Throwing power | 68.7 | 71.0 |
| Gas pin hole resistance (ΔV) | 60 | 50 |
| Average particle size of binder resin | 75 | 85 |
| emulsion (nm) | | |
| Dried film thickness (μm) | 15 | 15 |

TABLE 4

| | Comparative Example No. | | | |
|---|---|---|---|---|
| | 4 | 5 | 6 | 7 |
| Epoxy equivalent of emulsion | 800 | 2000 | 650 | — |
| resin (c) | | | | |
| Quaternary ammonium group | 77.5 | 32.4 | 32.4 | — |
| per 100 g of emulsion resin | | | | |
| (c) (meq) | | | | |
| Amount of amine-modified | 1.5 | 1.5 | 1.5 | 0 |
| novolac type epoxy resin | | | | |
| (solid content) | | | | |
| Electrical conductivity | 1660 | — | 1265 | 1720 |
| of electro-deposition | | | | |
| coated film (μS/cm) | | | | |
| Membrane resistance of | 1390 | — | 1400 | 760 |
| electro-deposition coated | | | | |
| film (kΩ · cm²) | | | | |
| Throwing power | 74.0 | — | 66.8 | 42.0 |
| Gas pin hole resistance (ΔV) | 20 | — | 60 | −10 |
| Average particle size of | 120 | Not Em.* | 135 | 70 |
| binder resin emulsion (nm) | | | | |
| Dried film thickness (μm) | 15 | 15 | 15 | 15 |

*Not Em.: It can not be emulsified.

As is apparent from the results shown in Table 1 and Table 2, the cationic electrodeposition coating compositions of the present invention of Examples 1 and 2 had high throwing power, and low unevenness of drying. As is apparent from the results of Examples, particularly, the cationic electrodeposition coating compositions of the present invention had low content of organic solvent compared with that of Comparative Examples. The electrodeposition coating compositions of the present invention has the advantage of having low content of organic solvent, high throwing power and low unevenness of drying.

As is apparent from the results shown in Table 3 and Table 4, the cationic electrodeposition coating compositions of the present invention of Examples 3 and 4 had high throwing power and excellent performance of restraining the occurrence of gas pin hole. As is apparent from the results of Examples, particularly, the electrodeposition coating compositions of the present invention has small amount of the acid for neutralization used for preparing the electrodeposition coating composition compared with the conventional electrodeposition coating compositions of Comparative Examples. The electrodeposition coating compositions of the present invention has the advantage of having excellent stability even if the amount of the acid for neutralization is small, high throwing power and excellent performance of restraining the occurrence of gas pin hole.

What is claimed is:

1. A method for making an amine-modified epoxy resin comprised in a cationic electrodeposition coating composition comprising the steps of:
providing a half blocked isocyanate by reaction of an isocyanate compound with a blocking agent,
preparing a blocked prepolymer by reaction of the half blocked isocyanate with a polyol,
forming an epoxy resin containing oxazolidone ring by reaction of the blocked prepolymer with a diglycidyl ether type epoxy resin,
chain-extending the epoxy resin containing oxazolidone ring with at least saturated or non-saturated hydrocarbon group containing dicarboxylic acid, and
modifying the chain-extended epoxy resin with an amine.

2. The method according to claim 1, wherein the diglycidyl ether type epoxy resin has an epoxy equivalent of 150 to 1,000.

3. The method according to claim 1, wherein the epoxy resin containing oxazolidone ring has an epoxy equivalent of 800 to 3,000.

4. The method according to claim 1, wherein the amine-modified epoxy resin has a dynamic glass transition temperature Tg of 18 to 35° C.

5. The method according to claim 1, wherein the amine-modified epoxy resin has a content of diglycidyl ether moiety containing oxazolidone ring of 30 to 70% by weight.

6. The method according to claim 1, wherein the amine-modified epoxy resin has a content of dicarbonyl moiety containing saturated or non-saturated hydrocarbon group of 3 to 17% by weight.

7. A lead-free cationic electrodeposition coating composition comprising the amine-modified epoxy resin formed by the method according to claim 1.

8. The lead-free cationic electrodeposition coating composition according to claim 7 comprising an organic solvent in an amount of not more than 0.5%.

9. The lead-free cationic electrodeposition coating composition according to claim 7, wherein the electrodeposition coated film having a thickness of 15 μm has a membrane resistance of 1,000 to 1,500 kΩ·cm².

10. A cationic electrodeposition coating composition comprising a binder resin emulsion comprising
a binder resin formed from (a) an amine-modified bisphenol type epoxy resin having an amino group; and (b) a blocked isocyanate curing agent; and
an emulsion resin formed from (c) a modified epoxy resin having a quaternary ammonium group, wherein the emulsion resin has an epoxy equivalent of 1,000 to 1,800, and has 35 to 70 meq of the quaternary ammonium group, based on 100 g of the emulsion resin (c).

11. The cationic electrodeposition coating composition according to claim 10, wherein the binder resin emulsion has a solid content ratio of (a) the amine-modified bisphenol type epoxy resin having an amino group and emulsion resin formed from (c) a modified epoxy resin having a quaternary ammonium group is 98:2 to 70:30.

12. The cationic electrodeposition coating composition according to claim 10 having an electrical conductivity of 1,200 to 1,600 μS/cm.

13. The cationic electrodeposition coating composition, wherein the cationic electrodeposition coated film having a thickness of 15 μm formed from the cationic electrodeposition coating composition according to claim 10 has a membrane resistance of 900 to 1,600 kΩ·cm².

14. A process for forming an electrodeposition coated film having restrained occurrence of gas pin pole comprising the step of dipping a material to be coated with the cationic electrodeposition coating composition according to claim 10 to conduct electrodeposition coating.

15. A process for forming an electrodeposition coating having a dry thickness of greater than 10 μm comprising the step of dipping zinc galvanized steel plate with the cationic electrodeposition coating composition according to claim 10 to conduct electrodeposition coating.

16. A method of restraining the occurrence of gas pin hole when conducting electrodeposition coating having high throwing power, wherein the cationic electrodeposition coating composition used in the step of conducting electrodeposition coating comprises a binder resin emulsion emulsified by an emulsion resin (c) having an epoxy equivalent of 1,000 to 1,800, and has 35 to 70 meq of the quaternary ammonium group, based on 100 g of the emulsion resin.
